(19) United States
(12) Patent Application Publication
(10) Pub. No.: US 2023/0260002 A1
(43) Pub. Date: Aug. 17, 2023

(54) SYSTEMS AND METHODS FOR DETERMINING ITEM QUALITY INDEX SCORES IN AN ONLINE RETAIL ENVIRONMENT

(71) Applicant: Target Brands, Inc., Minneapolis, MN (US)

(72) Inventors: Toni Ghilani, Minneapolis, MN (US); Javan Copley, Minneapolis, MN (US); Jason Lavik, Minneapolis, MN (US); Brad Arbach, Minneapolis, MN (US); Rebecca Lawler, Minneapolis, MN (US); Dakota R. Brown, Minneapolis, MN (US)

(21) Appl. No.: 18/105,060

(22) Filed: Feb. 2, 2023

Related U.S. Application Data
(60) Provisional application No. 63/309,884, filed on Feb. 14, 2022.

(51) Int. Cl. G06Q 30/0601

(52) U.S. Cl. CPC G06Q 30/0627; G06Q 30/0633

(57) ABSTRACT

Disclosed are systems and methods for determining quality of item listings in an online retail environment. A method can include receiving, by a computing system, item listing data having information about items of item categories available in the online retail environment for purchase at computing devices of end consumers, determining, for each of the item categories, one or more quality index scores based on the information included in the item listing data, determining, for each of the item categories, a composite quality index score based on aggregating the quality index scores for the items in each of the item categories, and generating, based on the composite quality index score, output for each of the item categories for presentation on a display screen of a computing device of a retail employee. The quality index scores can quantify quality levels of the item listing data.

### INCORPORATION BY REFERENCE

This application claims priority to U.S. Provisional Application Ser. No. 63/309,884, filed on Feb. 14, 2022, the disclosure of which is incorporated by reference in its entirety.

### TECHNICAL FIELD

This document describes devices, systems, and methods related to measuring and improving quality of item listing data in online retail environments to improve system efficiency and resource utilization.

### BACKGROUND

Online retail environments, such as retail websites, can sell items (e.g., products) to end consumers. End consumers can search for items on the online retail environments and decide whether to purchase items and which items to purchase based on information presented about the items thereon. Each item can have a listing on the online retail environment. The listing can include information about the item, such as a title, price, and description. Sometimes, item listings may be missing information, outdated, incomplete, or duplicative. When item listings are incomplete and/or inaccurate, end consumers may be less inclined to purchase those items and may experience a lower shopping experience. Sometimes, the end consumers may have less confidence in the items that are being sold and therefore may not purchase items from that online retail environment.

### SUMMARY

The document generally relates to determining and improving quality of item listings on online retail environments. More specifically, this disclosure can provide for generating a composite item quality index (IQI) score for an item based on a variety of differently scored and weighted IQI scoring metrics (e.g., dimensions) that correspond to data and content associated with an item listing. The scoring metrics can include completeness, accuracy, uniqueness, timeliness, validity, and consistency. These scoring metrics can be used to improve listing information including by eliminating duplicative, unnecessary, or incorrect data to conserve memory storage resources in a computing system.

Referring to the above mentioned example IQI scoring metrics, data completeness can be a question of how much data is populated as opposed to being blank in the item listing. Accuracy can refer to how much information is correct in the item listing. Uniqueness can refer to whether any item information, such as a barcode or other unique item identifier, is used for another item in the same computing system and/or across different systems. Timeliness can refer to how recent and frequent data for the item listing has been updated. Validity can refer to whether data is in a specific, useable format, follows business or other logic rules, and/or has permissible values. Finally, consistency can refer to whether data is consistent across datasets and different systems.

An item listing can be assigned individual IQI scores for each of the abovementioned metrics. These IQI scores can be weighted differently based on their importance in delivering quality and an improved shopping experience to end consumers. Over time, the weights can shift as importance of one or more metrics become more prevalent. The weights can also vary depending on item type and/or category of items. Machine learning techniques (e.g., machine learning trained models, algorithms, etc.) can be used in some implementations to dynamically and automatically modify weights for each metric. Once the individual IQI scores are weighted, they can be aggregated to determine the composite IQI score for the item listing (an individual item level). This disclosure can also provide for determining the composite IQI score of a particular category of items (an item category level). The composite IQI score can be a quantitative assessment of quality for a particular item listing and/or category of items. The composite IQI score as well as the individual IQI scores can provide insight into how to improve item listings to further improve end consumers' purchase decisions and shopping experiences. The composite IQI score (or combinations of one or more individual IQI score) can also be used to improve system performance and conserve system resources by eliminating duplicative, unnecessary, or unhelpful data or listings thereby reducing the memory storage requirements of the system overall.

One or more embodiments described herein can include method for determining quality of item listings in an online retail environment, the method can include receiving, at a computing system, item listing data that information about items of one or more item categories that are available in the online retail environment for purchase at user computing devices of end consumers, and determining, by the computing system and for each of the item categories, one or more quality index scores based on the information included in the item listing data. The one or more quality index scores can quantify one or more quality levels of the item listing data for the items in each of the item categories. The method can also include determining, by the computing system and for each of the item categories, a composite quality index score based on an aggregation of the determined one or more quality index scores for the items in each of the item categories, and generating, by the computing system and based on the determined composite quality index score, output for each of the item categories for presentation on a display screen of a user computing device of a retail employee.

In some implementations, the embodiments described herein can optionally include one or more of the following features. For example, determining, by the computing system and for each of the items categories, a composite quality index score can include weighting each of the determined one or more quality index scores, and averaging the weighted quality index scores to generate the composite quality index score.

As another example, generating, by the computing system and based on the determined composite quality index score, output for each of the item categories can include determining one or more operations that can be performed to improve at least one of (i) the composite quality index score and (ii) one or more of the determined quality index scores. The one or more operations can include instructions that, when executed by the computing system, cause a notification to be sent to the user computing device of the retail employee requesting updated information for one or more of the items in one or more of the item categories from a supplier of the one or more items. The one or more operations can also include instructions that, when executed by the computing system, cause a notification to be sent to the user computing device of the retail employee requesting input from the retail employee for updated information for one or more items in one or more of the item categories.

In some implementations, the one or more quality index scores can include an accuracy score, a completeness score, a timeliness score, a uniqueness score, a validity score, and a consistency score. Determining, by the computing system and for each of the item categories, a composite quality index score can include weighting each of the determined one or more quality index scores, and averaging the weighted quality index scores to generate the composite quality index score. The accuracy score can be weighted within a first range of 25-30% of the composite quality index score, the completeness score can be weighted within a second range of 20-25% of the composite quality index score, the timeliness score can be weighted within a third range of 10-15% of the composite quality index score, the uniqueness score can be weighted within a fourth range of 10-15% of the composite quality index score, the validity score can be weighted within a fifth range of 0-5% of the composite quality index score, and the consistency score can be weighted within a sixth range of 0-5% of the composite quality index score. The first range can be greater than the second range, the second range can be greater than the third range, the third range can be equal to the fourth range, the third and fourth ranges can be greater than the sixth range, and the sixth range can be greater than the fifth range.

The method can also include determining, by the computing system and for each of the item categories, the accuracy score based on identifying an average item certification value, identifying an average title accuracy value as an aggregation of title accuracy values for the items that is determined based on the corresponding item listing data, identifying an average package dimension accuracy as an aggregation of package dimension accuracy values for the items that is determined based on the corresponding item listing data, and averaging the average item certification value, the average title accuracy value, and the average package dimension accuracy value to generate the accuracy score. The average item certification value can be an aggregation of item certification values for the items that can be determined based on the corresponding item listing data. Identifying an average item certification value can include determining a quantity of end consumer reviews that certify one or more information in the item listing data for the items.

The method can also include determining, by the computing system and for each of the item categories, the completeness score based on identifying an average required merchandise type attribute (MTA) value as an aggregation of required MTA values for the items that is determined based on the corresponding item listing data, identifying an average content value as an aggregation of content values for the items that is determined based on the corresponding item listing data, and averaging the average required MTA value and the average content value to generate the completeness score.

In some implementations, generating, by the computing system and based on the determined composite quality index score, output for each of the item categories can include identifying a threshold quantity of missing required MTAs for one or more of the item categories, and generating output that includes the identified missing required MTAs and corresponding quantities of items that are missing the identified missing required MTAs in the respective item listing data.

Moreover, the identified missing required MTAs can include at least one of a targeted audience, stretch, color specific description, pattern group, color family, number of pieces, product weight, gender, apparel and accessories subtype, and garment neckline type.

Sometimes, generating, by the computing system and based on the determined composite quality index score, output for each of the item categories can include identifying a threshold quantity of vendors associated with missing required MTAs for one or more of the item categories, and generating output that includes at least the identified vendors.

The method can also include determining, by the computing system and for each of the item categories, the timeliness score based on determining a quantity of item listings that have been updated within a threshold period of time, and dividing the quantity of item listings that have been updated within the threshold period of time by a total quantity of item listings in the item category to generate the timeliness score.

In some implementations, the method can include determining, by the computing system and for each of the item categories, the uniqueness score based on identifying an average title uniqueness value as an aggregation of title uniqueness values for the items that is determined based on the corresponding item listing data, identifying an average barcode uniqueness value as an aggregation of barcode uniqueness values for the items that is determined based on the corresponding item listing data, and averaging the average title uniqueness value and the average barcode uniqueness value to generate the uniqueness score.

Sometimes, generating, by the computing system and based on the determined composite quality index score, output for each of the item categories can include generating output indicating the average title uniqueness value and the average barcode uniqueness value for each of the item categories.

In some implementations, the method can also include determining, by the computing system and for each of the item categories, the validity score based on identifying an average total quantity of item identifiers value as an aggregation of the quantity of item identifier values for the items that is based on the corresponding item listing data, identifying an average illegal taxonomy count as an aggregation of illegal taxonomy counts for the items that is determined based on the corresponding item listing data, and averaging the average total quantity of item identifiers value and the average illegal taxonomy count to generate the validity score.

Sometimes, generating, by the computing system and based on the determined composite quality index score, output for each of the item categories can include generating output indicating validity types for the item categories and an illegal taxonomy count for each of the validity types.

Sometimes, generating, by the computing system and based on the determined composite quality index score, output for each of the item categories can include identifying a threshold quantity of illegal merchandise types for one or more of the item categories, and generating output that includes at least the identified illegal merchandise types and illegal taxonomy counts that correspond to each of the identified illegal merchandise types.

In some implementations, generating, by the computing system and based on the determined composite quality index score, output for each of the item categories can include identifying a threshold quantity of illegal item types for one or more of the item categories, and generating output that includes at least the identified illegal item types and illegal taxonomy counts that correspond to each of the identified illegal item types.

The method can also include determining, by the computing system and for each of the item categories, the consistency score based on identifying an average total item identifiers value as an aggregation of item identifiers values for the items that is determined based on the corresponding item listing data, identifying an average inaccurate taxonomy count as an aggregation of inaccurate taxonomy counts for the items that is based on the corresponding item listing data, and averaging the average total item identifiers value and the average inaccurate taxonomy count to generate the consistency score.

In some implementations, generating, by the computing system and based on the determined composite quality index score, output for each of the item categories can include generating output indicating consistency types for the item categories and an inaccurate taxonomy count for each of the consistency types. Generating, by the computing system and based on the determined composite quality index score, output for each of the item categories can also include identifying a threshold quantity of inaccurate merchandise types for one or more of the item categories, and generating output that includes at least the identified inaccurate merchandise types and consistency taxonomy counts that correspond to each of the identified inaccurate merchandise types.

In some implementations, generating, by the computing system and based on the determined composite quality index score, output for each of the item categories can include identifying a threshold quantity of inaccurate item types for one or more of the item categories, and generating output that includes at least the identified inaccurate item types and consistency taxonomy counts that correspond to each of the identified inaccurate item types.

Moreover, the one or more item categories can include apparel and accessories, beauty and cosmetics, essentials, food and beverage, hardlines, and home.

In some implementations, the accuracy score can quantify an accuracy of the item listing data for the items in each of the item categories, the completeness score can quantify how much content is included in the item listing data for the items in each of the item categories, the timeliness score can quantify how recent the item listing data for the items in each of the item categories has been updated and how often the item listing data for the items in each of the item categories is updated, the uniqueness score can quantify whether the item listing data for the items in each of the item categories has a unique item title and item identifier, the validity score can quantify whether the item listing data for the items in each of the item categories includes legal fields, values, and taxonomy, and the consistency score can quantify whether the item listing data for the items in each of the item categories is consistent across one or more different computing systems and data stores.

In some implementations, the method can also include determining, by the computing system, updated weights for the one or more quality index scores based on applying a machine learning model to historic item listing data, and weighting, by the computing system, the one or more quality index scores with the updated weights. The machine learning model can be trained using training data sets to correlate historic quality index scores with current trends in end consumer purchase decisions and end consumer feedback about the items in each of the item categories to determine the updated weights for the corresponding one or more quality index scores.

In some implementations, the method can also include determining, by the computing system, a score weight for each of the quality index scores based on historical changes made to the item listing data of the items in each of the item categories as a result of the item listing data having been assigned a low quality index score, and weighting each of the quality index scores using the determined score weights.

One or more embodiments described herein can include a computing system for determining quality of item listings in an online retail environment, the computing system including one or more processors and one or more computer-readable devices including instructions that, when executed by the one or more processors, cause the computing system to perform operations that include: receiving item listing data, determining, for each of the item categories, one or more quality index scores based on the information included in the item listing data, determining, for each of the item categories, a composite quality index score based on an aggregation of the determined one or more quality index scores for the items in each of the item categories, and generating, based on the determined composite quality index score, output for each of the item categories for presentation on a display screen of a user computing device of a retail employee.

In some implementations, the embodiments described herein can optionally include one or more of the above mentioned features.

The devices, system, and techniques described herein may provide one or more of the following advantages. For example, the disclosed techniques can improve end consumer confidence in item listings, an online retail environment, purchase decisions, and shopping experiences. This can be achieved by automatically and quickly aggregating and analyzing item listing data across different systems, which otherwise may be time-consuming or impossible by a human, such as a retail store employee. The disclosed techniques can also prioritize review and improvement of item listing data that is critical to consumer confidence and decisions to purchase from the online retail environment. Thus, the right data quality problems can be identified and addressed quickly using such automated techniques. Additionally, improving consumer experiences can improve online retail sales.

Moreover, the disclosed techniques can be beneficial to increase convenience of navigating the online retail environment and finding desirable items. Consumers can more easily find items they wish to purchase when they can search for different features or information about items that are accurately recorded across datasets and different computing systems. Since the disclosed techniques provide for improving item listing data by ensuring the item listing data is complete, accurate, consistent, timely, unique, and valid, consumers can search and more easily find the items they wish to purchase. This can further improve consumer confidence, their purchasing decisions, and their overall shopping experiences. This improved searchability can also decrease the amount of time that each customer engages with the system during a particular session, thereby reducing processing and communication bandwidth requirements for the system, which frees up these resources for other purposes.

As another example, IQI scoring can provide an automated approach for culling different types of data from a variety of sources to identify whether item listings are of high quality and/or what improvements can be made to improve item listing quality. The disclosed techniques can integrate data from multiple different systems (e.g., computers, devices, networks, databases, etc.) with automated flagging indicating one or more particular metrics (e.g., accuracy, completeness, uniqueness, timeliness, validity, and consistency) that may result in a low composite IQI score and therefore should be addressed. Furthermore, using the disclosed techniques, information can be corrected in an automated way, which can provide for deleting or otherwise removing duplicative or unnecessary information stored in the multiple different systems. This can improve use of computational resources, processing power, and efficiency of the different systems.

Automatically determining a composite IQI score for a particular item and/or a category of items based on an aggregation of the individual IQI scores can provide insight into what particular data can and should be modified, added, and/or removed. It can be a time-consuming and tedious process for retail employees to manually perform an audit process of each item listing in the retail environment. Sometimes, the retail employees may make errors or overlook data in an item listing that should be corrected. Since it can be challenging for retail employees to thoroughly review item listing data across various different systems, the retail employees may make errors or overlook data that can and should be improved. Thus, a retail employee's assessment of quality may not be accurate or up to date. The disclosed techniques, on the other hand, provide an automated and quick approach for auditing and synthesizing item data across different systems, which otherwise may not be feasible by a human reviewer. The disclosed techniques can remove potential human error, reduce an amount of time needed to audit every item listing across the different systems, and provide more valuable and accurate insights into what particular modifications can be made to item listings in order to provide higher quality information to consumers.

Moreover, automatically determining quality of item listings based on 6 IQI scoring metrics (e.g., dimensions, features) can provide a more detailed and accurate quality control analysis of item listings in comparison to manual review by retail employees. For example, determining that data completeness, content completeness, and data accuracy can be improved for a particular item listing may provide more structured/direct guidance to relevant users (e.g., suppliers, retail employees, quality control analysts, etc.) about how to update the item listing to improve consumer purchasing and shopping experiences. Determining timeliness of data can also be beneficial to ensure accurate insights (e.g., sales reporting) and business decisions that are made for the online retail environment. Determining uniqueness can be beneficial to ensure each item is uniquely identified, thereby avoiding consumer confusion about availability of items or other issues. Determining consistency can be beneficial to ensure that consumers receive all the important and necessary information, such as return policies and warranties, to make the right purchasing decisions. Finally, determining validity can be beneficial to determine what data should be shared with consumers to help them in their purchasing and shopping decisions. By determining each of these IQI scoring metrics for an item listing (as well as a category of items), the disclosed techniques can provide a comprehensive and accurate approach to assessing item quality, improving item quality, and enhancing consumer purchasing and shopping experiences in an automated way.

As another example, the disclosed techniques provide for increased speed at which data quality issues are automatically remediated. Data quality issues can be resolved automatically, quickly, and accurately, thereby improving overall quality offered by the retail environment and improved consumer experiences. Automatic remediation can be beneficial to reduce an amount of time needed by relevant users (e.g., retail employees) to comb through item listing data, determine what can be improved, and make the improvements themselves. Automatic remediation can allow for the relevant users to focus their attention on other tasks. Automatic remediation can also allow for reducing or otherwise avoiding human error that may occur if the relevant users spend their time manually fixing data quality issues. Moreover, automatic remediation can result in increased scalability and extensibility of the disclosed techniques, thereby providing for vast and real-time improvement of item listings and overall data quality for the retail environment.

The details of one or more implementations are set forth in the accompanying drawings and the description below. Other features and advantages will be apparent from the description and drawings, and from the claims.

### BRIEF DESCRIPTION OF THE DRAWINGS

FIG. 1A is an example item listing in an online retail environment.

FIG. 1B is example output generated based on the composite IQI score that is determined for the example item listing of FIG. 1A.

FIG. 2 is a conceptual diagram for determining a composite IQI score.

FIG. 3 is a flowchart of a process for determining a composite IQI score.

FIG. 4A is a flowchart of a process for assessing composite IQI scores of different item categories.

FIG. 4B is a flowchart of a process for assessing one or more individual IQI scores for a particular item category.

FIG. 5 is a flowchart of a process for assessing one or more individual IQI scores for a particular item listing.

FIG. 6 illustrates an example user interface presenting a composite IQI score.

FIG. 7 illustrates an example user interface presenting an accuracy IQI score, which can be one of the individual IQI scores that comprises the composite IQI score.

FIG. 8 illustrates an example user interface presenting a completeness IQI score, which can be one of the individual IQI scores that comprises the composite IQI score.

FIG. 9 illustrates an example user interface presenting a timeliness IQI score, which can be one of the individual IQI scores that comprises the composite IQI score.

FIG. 10 illustrates an example user interface presenting a uniqueness IQI score, which can be one of the individual IQI scores that comprises the composite IQI score.

FIGS. 11A-E illustrate an example user interface presenting a validity IQI score, which can be one of the individual IQI scores that comprises the composite IQI score.

FIGS. 12A-E illustrate an example user interface presenting a consistency IQI score, which can be one of the individual IQI scores that comprises the composite IQI score.

FIG. 13 is a system diagram depicting one or more components that can be used to perform the techniques described herein.

FIG. 14 is a schematic diagram that shows an example of a computing device and a mobile computing device.

Like reference symbols in the various drawings indicate like elements.

### DETAILED DESCRIPTION OF ILLUSTRATIVE EMBODIMENTS

This document generally relates to automatically analyzing and determining quality of item listings and/or categories of items in an online retail environment. This disclosure can provide actionable insights into health of item listing data by prioritizing the right data quality problems that deliver the most value to users (e.g., end consumers, customers) to thereby improve user purchase confidence and shopping experiences. In other words, the disclosed techniques can be used to determine descriptive aspects of an item listing that provide the most value to users and may need to be improved. A composite IQI score can be automatically determined for each item listing and/or category of items based on an aggregation of differently scored and weighted IQI scoring metrics (e.g., dimensions). The metrics can include any combination of completeness, accuracy, uniqueness, timeliness, validity, and consistency. These metrics can be weighted based on their respective importance in providing quality information to users. The weighting can be automatically and dynamically modified over time (e.g., using machine learning techniques such as machine learning trained models) and can also differ depending on an item type.

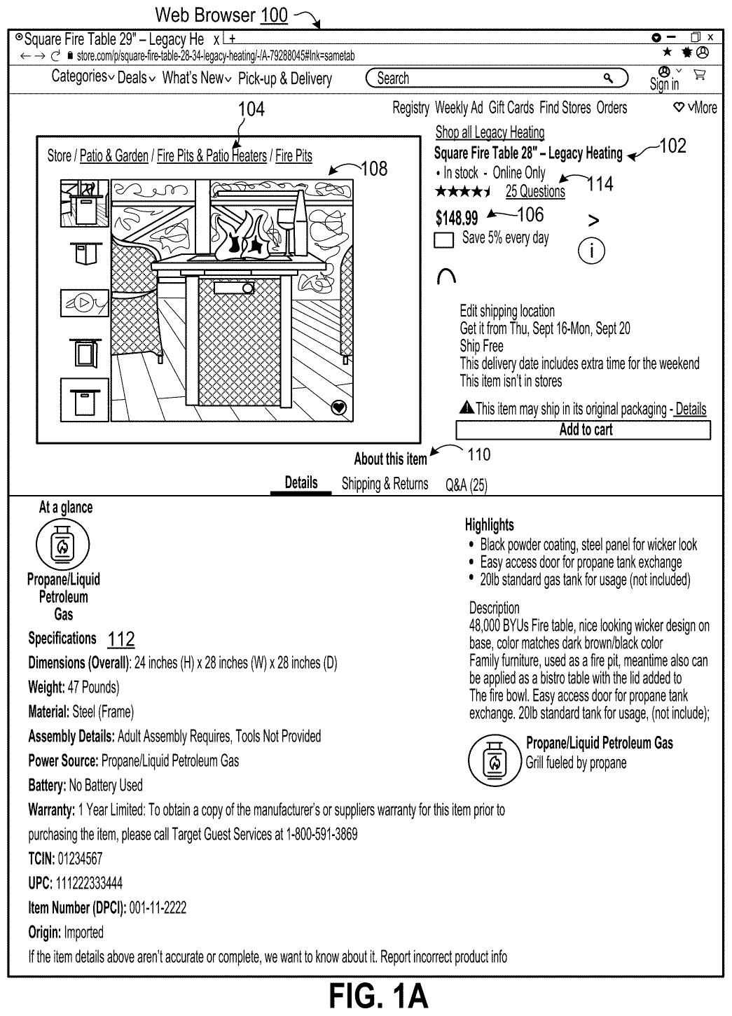

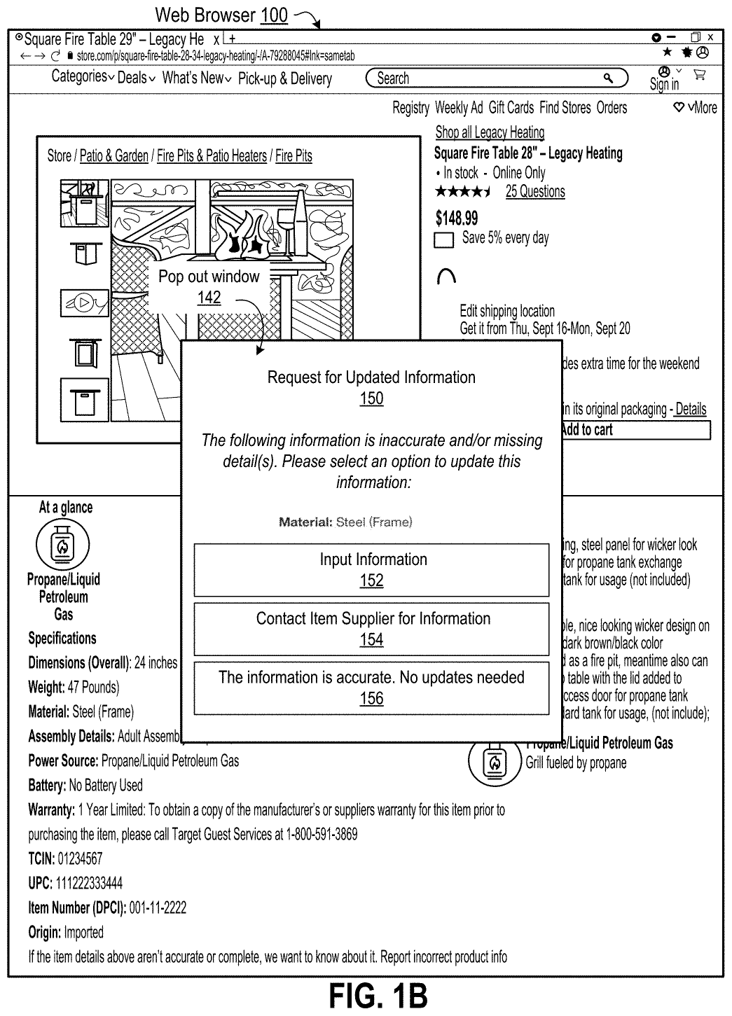

FIG. 1A shows an example item listing in an online retail environment. The online retail environment can be a website 100 that is loaded in a web browser at a computing device, such as a user device (e.g., client device, client computing device). The computing device can be any one of a computer, laptop, tablet, cellphone, mobile phone, and/or smart phone. The website 100 can display selectable options for a user to navigate the online retail environment, search for items to purchase, log into and access user account information, review items to purchase, and purchase items.

The example of FIG. 1A depicts an item listing for a fire table. The item listing includes a title 102. In this example, the title 102 is “Square Fire Table 28”—Legacy Heating.” The item listing includes a taxonomy 104 associated with the fire table. The taxonomy 104 indicates that the fire table is part of Patio & Garden>Fire Pits & Patio Heaters>Fire Pits. The item listing further includes a price 106. Here, the price 106 is $148.99. Image data 108 is also presented at the website 100. The image data 108 includes one or more images and/or videos depicting the fire table from various angles, how to use the fire table, and/or how to set up the fire table.

The item listing includes additional information about the fire table, which can be included in an About this item section 110. The section 110 can include tabs for information such as details, shipping and returns, reviews, questions and answers, etc. that may assist users in making purchase decisions. Users can navigate the section 110 by selecting the tabs described herein. One or more additional or fewer tabs can also be presented in the section 110, which can depend on the particular item, policy/guidelines of a supplier of the item, and/or policy/guidelines of the particular online retail environment.

The example section 110 in FIG. 1A includes “At a glance” information, which can provide a high level overview of what the item is and/or relates to, “Highlights” information about the item, specifications 112, and a description of the item. One or more other information can be presented in the section 110. The item listing can include additional information, such as customer reviews 114, which can assist users in making purchase decisions. The customer reviews 114, as described herein, can also be used to automatically assess quality of the item listing data based on one or more of the IQI scoring metrics (e.g., dimensions).

Any one or more of the title 102, the taxonomy 104, the price 106, the image data 108, the About this item section 110, the specifications 112, and the customer reviews 114 can be assessed using the disclosed techniques to determine a composite IQI score for the particular item listing. As mentioned throughout, the item listing can be assessed based on 6 IQI scoring metrics (e.g., dimensions) including accuracy, completeness, timeliness, uniqueness, validity, and consistency. For example, the disclosed techniques can be used to determine whether the title 102 is unique and/or accurately describes the fire table, whether the taxonomy 104 is accurate, consistent, and/or valid, whether the price 106 is accurate, whether the image data 108 is accurate, complete, and/or timely, whether the About this item section 110 and the specifications 112 (e.g., dimensions/measurements, color, weight, barcode or other identifier, etc.) are accurate, complete, timely, unique, valid, and/or consistent, and whether the customer reviews 114 are accurate and/or timely. Components of the item listing can be used to score the item listing based on multiple IQI scoring metrics. For example, the title 102 can be used to score the fire table listing on both the uniqueness metric and the accuracy metric.

The individual IQI scores can then be aggregated to determine a composite IQI score for the particular item listing. The composite IQI score for the fire table listing can, for example, be presented to a relevant user (e.g., retail store employee, quality control analyst) or computing system. The relevant user and/or computing system can make decisions about how to improve the quality of the item listing. Such decisions can be facilitated by focusing on item listings that are assigned composite IQI scores less than predetermined threshold values. Such decisions can further be refined and focused on particular item listings having individual IQI scores below predetermined threshold ranges. This can be beneficial to improve accuracy and efficiency in quality control of item listings.

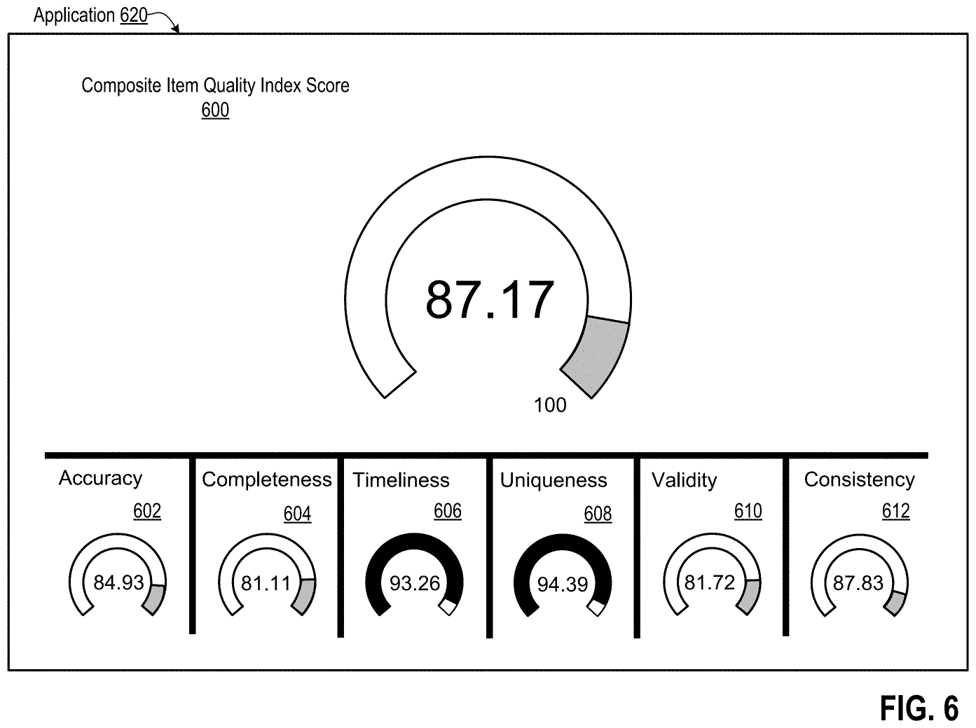

FIG. 1B is example output generated based on the composite IQI score that is determined for the example item listing of FIG. 1A. As mentioned in reference to FIG. 1A, the composite IQI score can be determined based on an aggregation of scores for IQI scoring metrics including accuracy, completeness, timeliness, uniqueness, validity, and consistency. Once the composite IQI score is determined for the particular item listing (or a category of items), output can be generated, as described further below. The output can be presented in a variety of different graphical user interfaces (GUIs) at a user device. For example, the output can include a pop out or other window presented at a website that is assessed/analyzed by a relevant user, such as a retail employee and/or a quality control analyst (e.g., refer to FIG. 1B). The output can also include a variety of GUIs presented in a software package or application that is used by the relevant user (e.g., refer to FIGS. 6-12).

The output can indicate the composite IQI score for the particular item listing. The output can also include a breakdown of scores for each of the IQI scoring metrics in addition to or instead of the composite IQI score. In some implementations, the output can include an indication of what information is missing, needs to be corrected, or otherwise should be reviewed or revised for the item listing. The output can also provide the relevant user with one or more options to address aspects of the item listing that are of low quality.

The output in FIG. 1B corresponds to one item listing: the fire table from FIG. 1A. In the illustrative example of FIG. 1B, a pop out window 142 appears in website 140 once the item listing for the fire table is analyzed using the disclosed technology and techniques. In some implementations, the pop out window 142 can be in the form of a notification, alert, email, and/or message presented to the relevant user in another interface, mobile application, application, software package, and/or system.

Here, the pop out window 142 includes a request for updated information 150. Information presented in the pop out window 142 can vary depending on the composite IQI score for the particular item listing. For example, if the composite IQI score is greater than some predetermined threshold range and/or value, no output may be presented. In other words, the item listing is of sufficient quality and therefore does not require attention from the relevant user. If the composite IQI score is greater than the predetermined threshold range and/or value, output may still be presented to the relevant user indicating that no action is needed at the present time. As another example, if the composite IQI score is less than some predetermined threshold range and/or value, the request 150 can be generated and outputted in the pop out window 142. As described herein, one or more other forms of output can also be presented to the relevant user (e.g., refer to FIGS. 6-12).

The request 150 states “The following information is inaccurate and/or missing detail(s). Please select an option to update this information:” and lists “Material: Steel (Frame)” from the item listing (e.g., refer to the specifications 112 in FIG. 1A) as what needs to be addressed. The request 150 can include one or more other statements about information that should be addressed in the item listing. In some implementations, the request 150 may simply state that the specifications 112 are incomplete (which can result in a completeness IQI score that is less than a predetermined threshold value) and request the relevant user to review the specifications 112. Here, the request 150 additionally includes selectable options (e.g., buttons) for the user to take action. For example, the user can select an “input information” option 152, a “contact item supplier for information” option 154, and a “the information is accurate. No updates needed” option 156. The request 150 can include one or more additional, fewer, or other selectable options, including but not limited to text fields, other input fields, and drop down menus.

By selecting the “input information” option 152, the user can directly provide input that can be used to automatically update the information in the item listing. For example, the user can type into an input field a correct material of the fire table. The user can provide the input in another, separate pop out window. The user can also provide the input in the pop out window 142.

By selecting the “contact item supplier for information” option 154, a notification can be automatically sent to the supplier of the fire table requesting updated information about the material of the fire table. In some implementations, by selecting the option 154, the user can be presented with contact information for the supplier. As a result, the user can contact the supplier to request the updated information for the fire table.

By selecting the “the information is accurate. No updates needed” option 156, the pop out window 142 can be closed and/or the request 150 can be resolved. For example, a notification can be sent to a data store or a computing system that assessed the item listing. The notification can indicate that all information is actually up to date and of sufficient quality to assist consumers in making purchase decisions.

FIGS. 1A-B are described in reference to determining a composite IQI score of a particular item listing. As described further below, the disclosed techniques can be used to determine a composite IQI score for a category of items. Thus, the category of items can be scored based on the IQI scoring metrics, wherein scores for each of the metrics are determined based on analyzing listings for items of a particular item category. In some implementations, composite IQI scores can be determined for each item in the category and then aggregated to determine the composite IQI score for that category of items. In some implementations, scores for each of the metrics can be determined on an item listing level, then aggregated by metric to determine the composite IQI score for the category of items.

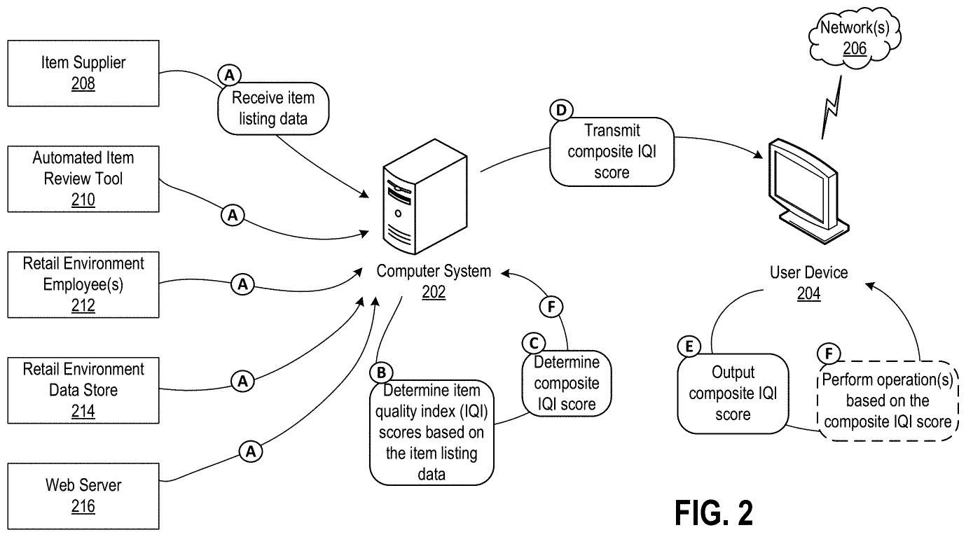

FIG. 2 is a conceptual diagram for determining a composite IQI score. As described herein, the composite IQI score can be determined for a particular item listing on an online retail environment. The composite IQI score can also be determined for a particular category of items on the online retail environment.

A computer system 202 and a user device 204 can be in communication (e.g., wired and/or wireless) via network(s) 206. The computer system 202 can be a cloud-based service and/or system, computing device, and/or network of computing devices, systems, or servers. The user device 204 can be a client computing device, including but not limited to a computer, laptop, tablet, mobile phone, smartphone, and/or cellphone. The user device 204 can be used by a relevant user, such as a retail employee and/or a quality control analyst. Although depicted as separate, in some implementations, the computer system 202 and the user device 204 can be a same computing system.

To determine the composite IQI score for a particular item listing and/or a category of items, the computer system 202 can receive item listing data from one or more sources (step A). The item listing data can include item listings as shown and described in FIG. 1A. The item listing data can include information about an item that is listed for sale on the online retail environment. The information can include but is not limited to title, taxonomy, price, description, customer reviews, image data, specifications, etc. The computer system 202 can receive the item listing data from an item supplier 208, automated item review tool 210, retail environment employee(s) 212, retail environment data store 214, and/or web server 216. The computer system 202 can receive item listing data from one or more other sources in some implementations.

The item supplier 208 can include a cloud-based system or server, a computing system, and/or a data store that maintains information (e.g., title, description, images, dimensions, weight, other specifications, etc.) about items of the supplier. The item supplier 208 can update this information periodically and/or based on policies of the supplier. Whenever the item supplier 208 updates the information for a particular item, the item supplier 208 can transmit the updated information to the computer system 202. The computer system 202 can also poll the item supplier 208 at predetermined time intervals and/or periodically to see whether the item supplier 208 has updated any of the item information. If information has been updated, the item supplier 208 can respond to the poll by transmitting the information to the computer system 202. In some implementations, the item supplier 208 can transmit item listing data to the computer system 202 at predetermined time intervals (e.g., once a day, twice a day, whenever a new item is provided by the item supplier 208, etc.).

The automated item review tool 210 can be implemented at the computer system 202 and/or some client side device, such as a computing device of a consumer, retail employee, or quality control analyst. The tool 210 can be configured to scan item listing data as it is presented in a web browser at the computer system 202 and/or the client side device. The scanned item listing data can be transmitted to the computer system 202. The item listing data can be scanned periodically and/or at predetermined time intervals (e.g., once a day, twice a day, fifteen times a day, etc.). The tool 210 can be configured to transmit all data that appears in the item listing. In some implementations, the tool 210 can transmit only a portion of the data that appears in the item listing. For example, the tool 210 can be configured to identify fields in a specification of an item that are missing information (e.g., empty fields, null fields, etc.). Only those identified fields can then be sent to the computer system 202 for further analysis, for example.

In some implementations, the automated item review tool 210 can be a microservice or other application/program/software that can be run at the computer system 202, the user device 204, and/or another computing system. The tool 210 can be configured to receive image data of an item and/or an item listing and process that image data to detect item listing data. For example, the tool 210 can utilize optical character recognition (OCR) techniques to detect a title, description, barcode, and/or other unique identifier from the image data. Such detected data can then be transmitted to the computer system 202 for further analysis. Such detected data can also be transmitted to a data store for storage and future retrieval and analysis.

The retail environment employee(s) 212 can manually review one or more items that are listed on the online retail environment. The employee(s) 212 can, for example, manually review the items in a physical retail environment, such as checking their respective item identifiers (e.g., barcodes, SKUs, etc.), titles, descriptions, prices, weight, dimensions, and/or visual features. The employee(s) 212 can input their observations into an application or other service presented at a user device of the employee(s) 212, such as the user device 204. This input can be provided to the computer system 202 for further analysis. In some implementations, the employee(s) 212 can review item listing data on the online retail environment. Thus, the employee(s) 212 can review particular pieces of information in an item listing, such as customer reviews, title, description, taxonomy, image data, specification, etc. The employee(s) 212 can input information about their review of the item listing into an application or other service presented at their device, which can be transmitted to the computer system 202 for further analysis. In some implementations, the computer system 202 can receive random spot checks for items that are available in the physical retail environment (e.g., from the retail environment employee(s) 212, a mobile/robotic imaging machine in the physical retail environment, or any other systems, devices, and/or components described herein). These spot checks can be provided to the computer system 202 in step A for further analysis.

The retail environment data store 214 can be a database, data store, data repository, data lake, and/or cloud-based storage. The data store 214 can be configured to maintain information about each item that is listed in the online retail environment. The computer system 202 can therefore retrieve item listing data from the data store 214 in step A.

The web server 216 can provide item listing data to the computer system 202 when that item listing is loaded in a web browser at a client side device. The web server 216 can provide the entire item listing to the computer system 202. The web server 216 can also provide portions of the item listing and/or some pieces of data from the item listing to the computer system 202. The webserver 216 can provide the item listing data to the computer system 202 periodically (e.g., 15 times a day, once a day, every 5 hours, etc.), at predetermined time intervals, or whenever an item listing is requested and presented at a client side device.

In some implementations, the computer system 202 can automatically receive the item listing data in step A, for example, periodically or at predetermined time intervals. In some implementations, the computer system 202 may receive the item listing data only upon requesting that data from the one or more sources described above.

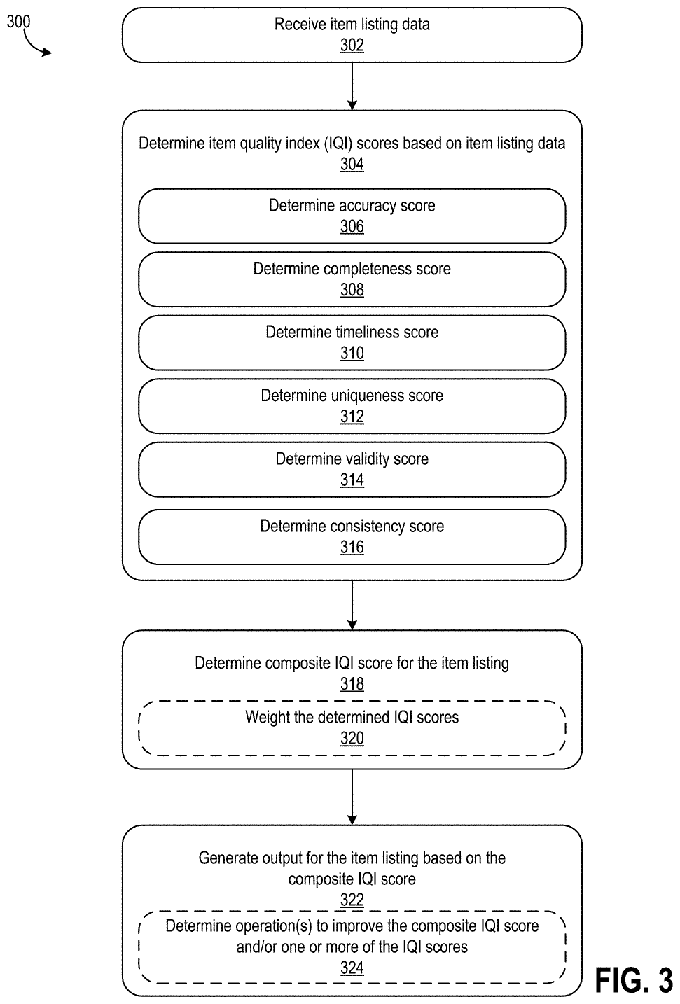

Once the computer system 202 receives the item listing data, the computer system 202 can determine individual IQI scores based on the item listing data (step B). As described further below, the computer system 202 can determine scores for each of the IQI scoring metrics: accuracy, completeness, timeliness, uniqueness, validity, and consistency of the item listing data. In some implementations, the computer system 202 may determine scores for less than all of the IQI scoring metrics. For example, IQI scores for the accuracy, timeliness, and consistency dimensions might have previously been determined for the item listing data. Therefore, the computer system 202 may determine IQI scores for completeness, uniqueness, and validity for the item listing data. As another example, a particular item listing can have a low completeness IQI score but all other IQI scores can be within expected ranges. Once updates are made to the item listing based on the completeness metric, the computer system 202 can re-compute only the completeness IQI score to determine whether the updates are sufficient to improve the overall quality of the item listing. As another example, the system can be configured to calculate only a subset of the IQI scores depending on, for example, an item type or classification. Refer to FIGS. 3 and 6-12 for further discussion about the IQI scoring metrics.

The computer system 202 can determine a composite IQI score based on the determined individual IQI scores (step C). As described further below, the computer system 202 can aggregate the individual IQI scores determined in Step B to reach the composite IQI score for the item listing. The computer system 202 can average the individual IQI scores to determine the composite IQI score. In some implementations, the computer system 202 can weight each of the individual IQI scores using one or more predetermined ranges/weights. Thus, one or more of the individual IQI scores may be weighed more heavily in the composite IQI score than other IQI scores based on which scoring metrics are more important in enhancing consumer purchasing decisions and shopping experiences at the online retail environment. Refer to FIG. 3 for further discussion.

The computer system 202 can transmit the composite IQI score to the user device 204 (step D). The computer system 202 can also transmit the determined IQI scores for the item listing to the user device 204. In some implementations, the computer system 202 can also transmit the composite IQI score and/or the determined IQI scores to a data store. As a result, the composite IQI score and/or determined IQI scores can be accessed, retrieved, and further processed at a later time.

The user device 204 can be a computing device such as a mobile device, computer, laptop, tablet, mobile phone, cellphone, and/or smartphone. The user device 204 can include one or more applications, programs, software, and/or services that allow a relevant user to review item listing data and perform operations to improve and/or modify that data. The relevant user can be, in some implementations, an employee of the retail environment and/or a quality control analyst.

When the composite IQI score is transmitted to the user device 204, the user device 204 can output it (step E). The user device 204 can also output the IQI scores for the item listing and any other information, including visualizations and/or graphical depictions that can be useful for the relevant user to assess and address quality concerns for the item listing. Refer to FIGS. 6-12 for further discussion.

The user device 204 can optionally perform one or more operations based on the composite IQI score (step F). The computer system 202 can also perform the one or more operations in step F. For example, if the composite IQI score falls within a predetermined threshold range and/or is less than some predetermined threshold value, the user device 204 and/or the computer system 202 can automatically transmit a notification to a supplier of the item. The notification can prompt the supplier to provide information that can be used to update the item listing and improve a particular IQI score and/or the composite IQI score of the item listing. In some implementations, the user device 204 and/or the computer system 202 can also communicate with one or more other systems, data stores, and/or networks to receive updated information for the item listing. Therefore, the user device 204 and/or the computer system 202 can, in some implementations, automatically update the item listing with accurate information.

Performing operations in step F by the computer system 202 can also include generating one or more suggestions for improving or otherwise addressing the composite IQI score and/or one or more individual IQI scores for the item listing. These suggestions can be presented to the user at the user device 204. The user can select and/or override one or more of the suggestions.

The steps A-F described in FIG. 2 can be automatically performed periodically, at predetermined time intervals, and/or by request of the user or another relevant user at the user device 204. For example, the steps A-F can be performed every 20 minutes, 30 minutes, 1 hour, 4 hours, once a day, etc. The steps A-F can be performed at different time intervals for different items and/or item categories. In some implementations the steps A-F are performed when a new item listing is added to the system (such as be being stored in a data store of the system). Steps A-F can also be performed whenever an item listing is updated in the system. Moreover, steps A-F can be performed in near real-time and/or in real-time.

FIG. 3 is a flowchart of a process 300 for determining a composite IQI score. As described throughout this disclosure, the process 300 can be performed to determine a composite IQI score for a particular item listing. The process 300 can also be performed to determine a composite IQI score for a category of items. Items can be associated with one or more categories. The categories can include but are not limited to apparel and accessories, beauty and cosmetics, essentials, food and beverages, hardlines, and home (e.g., home improvement, furniture, etc.). Hardlines can indicate divisions of categories/item types. Sometimes, these hardlines can be broader/genus categories. Example hardlines can include but are not limited to toys, sporting goods, entertainment (e.g., music, movies, books), home electronics, and mobile. In some implementations, each of these categories can further be broken down into sub-categories, all of which can also be assigned composite IQI scores. In some implementations, to determine a composite IQI score for a particular category, composite IQI scores can be determined for each item in the category, then aggregated/averaged to determine the composite IQI score for the category.

The process 300 can be performed by the computer system 202. The process 300 or one or more blocks of the process 300 can also be performed by one or more other computing systems, devices, cloud-based services, and/or networks of devices and/or systems. For illustrative purposes, the process 300 is described from the perspective of a computer system.

Referring to the process 300, the computer system can receive item listing data in 302. The item listing data can include information about one or more items of one or more item categories that are available in an online retail environment for purchase at devices of consumers. Refer to FIG. 2 for further discussion.

In 304, the computer system can determine IQI scores based on the item listing data. As described in reference to FIGS. 1-2, the computer system can determine the IQI scores based on some or all of the information that is received in 302. Some of the received information can be used to determine multiple IQI scores while other information may only be used to determine one IQI score for the particular item listing (or category of items).

Determining the IQI scores based on the item listing data can include determining an accuracy score (306), determining a completeness score (308), determining a timeliness score (310), determining a uniqueness score (312), determining a validity score (314), and determining a consistency score (316). Each of the determined IQI scores can measure a different quality metric (e.g., dimension, feature, attribute) that may affect consumer purchasing decisions and shopping experiences in the online retail environment. Thus, each of the determined IQI scores can indicate (e.g., measure, quantify) different aspects of quality of the item listing and whether improvements can and/or should be made to the item listing to improve its quality. The IQI scores can be determined on one or more scales. Each IQI score can be determined on a different scale, in some implementations. As an example, each of the IQI scores can be measured on a scale of 0 to 100, where 100 can be a highest quality IQI score and 0 can be a lowest quality IQI score. One or more other scales can be used.

The computer system can determine the accuracy score (306) based on information in the item listing data such as certification, product title, dimensions, and customer reviews. The more accurate the information, the higher the accuracy score. The accuracy score can measure how accurate information is that is presented in the item listing and/or stored in a data store or across different systems. The accuracy score can be determined using manual or automatic auditing of the item listing. For example, physical in-store audits can be performed on items to identify item data errors that may appear in the item listings online. As another example, automated audits can be performed of online item listings to identify errors. Consumer data insights (e.g., reviews, feedback, questions, tickets, etc.) can be used to identify, collect, and score accuracy issues in an item listing. In some implementations, computer vision techniques can be used to compare data from images of a particular item with data in the item's online listing and one or more data stores to determine accuracy of the item's listing data.

When determining the accuracy score for a particular item listing, the computer system can count information that is accurate and count information that is inaccurate in the item listing. The computer system can divide the count of accurate information by the total count of information analyzed to determine the accuracy score for the particular item listing. When determining the accuracy score for a category of items, the computer system can generate a count of item listings that contain accurate information and a count of item listings that do not contain accurate information. The computer system can divide the count of item listings having accurate information by a total count of item listings analyzed to determine the accuracy score for the category of items.

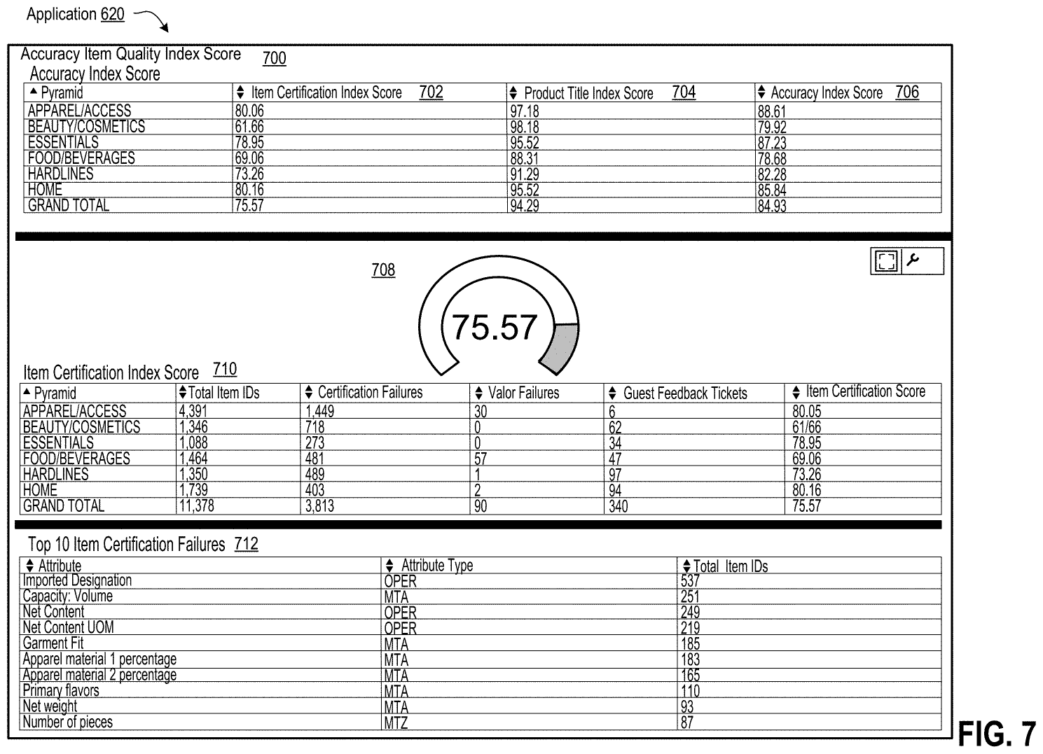

As depicted and described further in FIG. 7, the accuracy score can be an aggregate of one or more aspects of the accuracy metric. For example, the accuracy score for the particular item listing can be a combination (e.g., average, aggregation) of a certification score, a title score, and a dimensions (e.g., package dimensions) score assigned to the item listing based on auditing the received item listing data. As an illustrative example, the accuracy score can be determined based on identifying an average item certification value, which can be an aggregation of item certification values for the items in an item category that is determined based on the corresponding item listing data, identifying an average title accuracy value as an aggregation of title accuracy values for the items that is determined based on the corresponding item listing data, identifying an average package dimension accuracy as an aggregation of package dimension accuracy values for the items that is determined based on the corresponding item listing data, and averaging the average item certification value, the average title accuracy value, and the average package dimension accuracy value to generate the accuracy score. In some implementations, the average certification value can be identified based on determining a quantity of consumer reviews that certify one or more information in the item listing data. Semantic and/or textual analysis can be used by the computer system to assess the consumer reviews and correlate the reviews with item listing data. OCR techniques can also be used to identify the average item certification value. Refer to FIG. 7 for further discussion.

The computer system can determine the completeness score (308) based on identifying missing data such as images, videos, sizing charts, written text, descriptions, one or more specifications, etc. The completeness score can measure (e.g., quantify) how much information is filled in or otherwise included in the item listing. Completeness can measure how much of a dataset associated with the item listing is populated as opposed to being blank. The computer system can measure data completeness as well as content completeness. Data completeness can correspond to required merchandise type attributes (MTAs), which can be used to drive consumer experiences in the online retail environment. Content completeness can correspond to content in the item listing data, such as images, videos, size charts, etc.

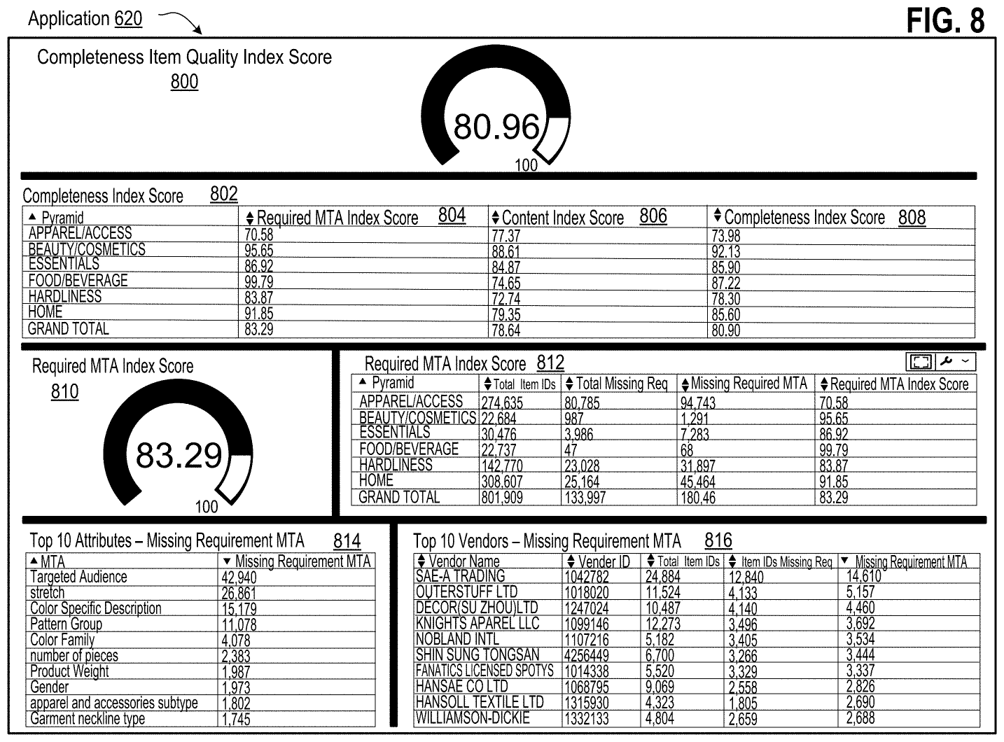

As depicted and described further in FIG. 8, the completeness score can be an aggregate of one or more aspects of the completeness metric. For example, the completeness score for the particular item listing can be a combination (e.g., average, aggregation) of a required MTA score and content score. As an illustrative example, the completeness score for a category of items can be determined based on identifying an average MTA value as an aggregation of required MTA values for the items according to the item listing data, identifying an average content value as an aggregation of content values for the items, and averaging the average required MTA value and the average content value to generate the completeness score. Averaging the two values can include summing the two values and dividing them by 2.

Moreover, as shown in FIG. 8, the computer system can generate output for the completeness score by identifying a threshold quantity of missing required MTAs for one or more of the item categories and generating output that includes the identified missing required MTAs and corresponding quantities of items that are missing the identified missing required MTAs in the respective item listing data. In some implementations, the identified missing required MTAs can include at least one of a targeted audience, stretch, color specific description, pattern group, color family, number of pieces, product weight, gender, apparel and accessories subtype, and garment neckline type. Such MTAs can be associated with a category of apparel and accessories. One or more other MTAs can be identified for other item categories. In some implementations, the computer system can identify a threshold quantity of vendors associated with missing required MTAs for one or more of the item categories and generate output that includes at least the identified vendors. A relevant user, such as a retail employee or a quality control analyst, can review the identified vendors and determine which of the vendors to contact with a request for information. Refer to FIG. 8 for further discussion.

The computer system can determine the timeliness score (310) based on identifying when and how often information in the item listing was or has been updated. For example, the computer system can determine a quantity of item listings that have been updated within a threshold period of time and divide the quantity of item listings that have been updated within the threshold period of time by a total quantity of item listings in a particular item category to generate the timeliness score. The threshold period of time can vary, as described below. For example, the threshold period of time can be 0-3 months, 3-6 months, 6 months, 6-12 months, 12+ months, etc.

The timeliness score can quantify how recent the item listing data has been updated and/or how often the item listing data is updated. Sometimes, merchandising teams can transition items (e.g., refresh their assortment) more than once per year. Because of this, each item listing should contain updated information from at least one source system (e.g., the computer system 202, the supplier 208, the retail environment data store 214, 3 etc.). Item listings that contain recently updated information can be assigned higher timeliness scores than item listings that have not been recently updated. Item listings that have not been updated in 12+ months, for example, can be assigned low timeliness scores while item listings that have been updated in the past 0-3 months can be assigned higher timeliness scores.

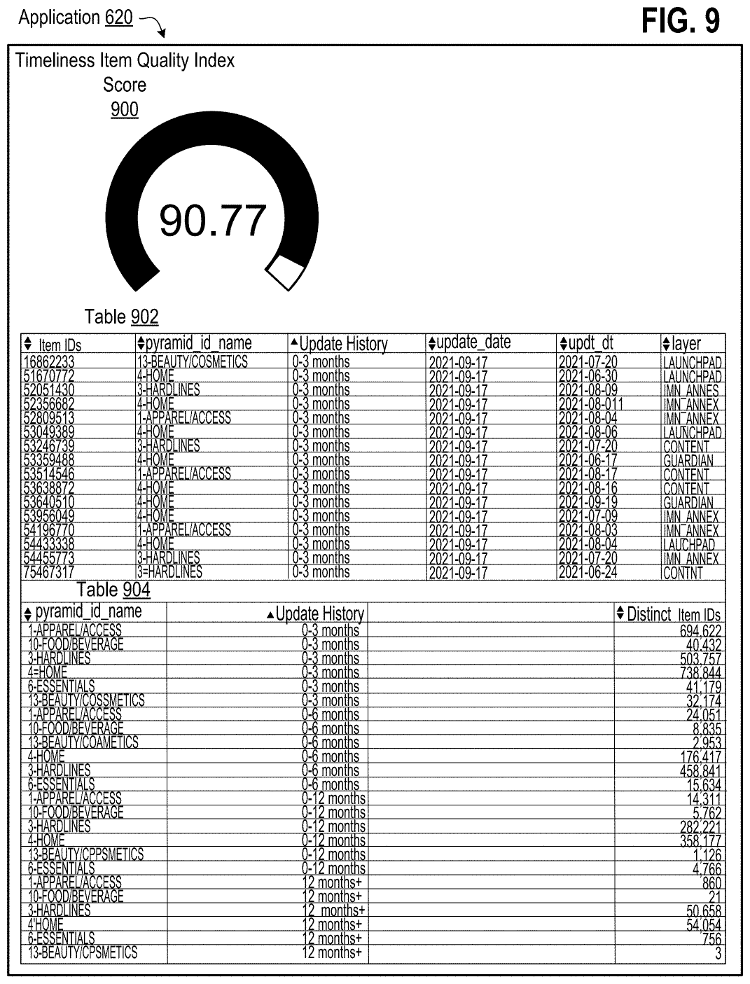

As depicted and described further in FIG. 9, the timeliness score can be an aggregate of one or more aspects of the timeliness metric. To determine the timeliness score, the computer system can review all item listings and measure/quantify when a last update (e.g., maintenance) was performed for each item listing. The timeliness score can be a percent (e.g., average) of item listings in a particular item category that were updated in the past 6 months (or another time period) divided by a total quantity of items in the category. In this manner, the timeliness score for a particular item listing is dependent on the last updated time for other item listings, in some implementations. The time period at which the timeliness score is determined can vary. In some implementations, the timeliness score can be based on when items were updated in the past 3 months, 4 months, 5 months, 6 months, etc. Refer to FIG. 9 for further discussion.

The computer system can determine the uniqueness score (312) based on identifying whether one or more data entries of the item listing are duplicated elsewhere, in other systems and/or data stores. The computer system can, for example, receive a title and identifier, such as a barcode, from the item listing data. The computer system can search one or more other systems and/or data stores to see whether the title and/or identifier appear for other item listings. Thus, the uniqueness score can quantify whether the item listing data has a unique title and/or item/product identifier (e.g., barcode, UPC, etc.). Each item should have its own unique identifier. Thus, if the item listing contains an identifier that is also used for another item listing, the item listing can be assigned a lower uniqueness score in comparison to an item listing that has a unique identifier.

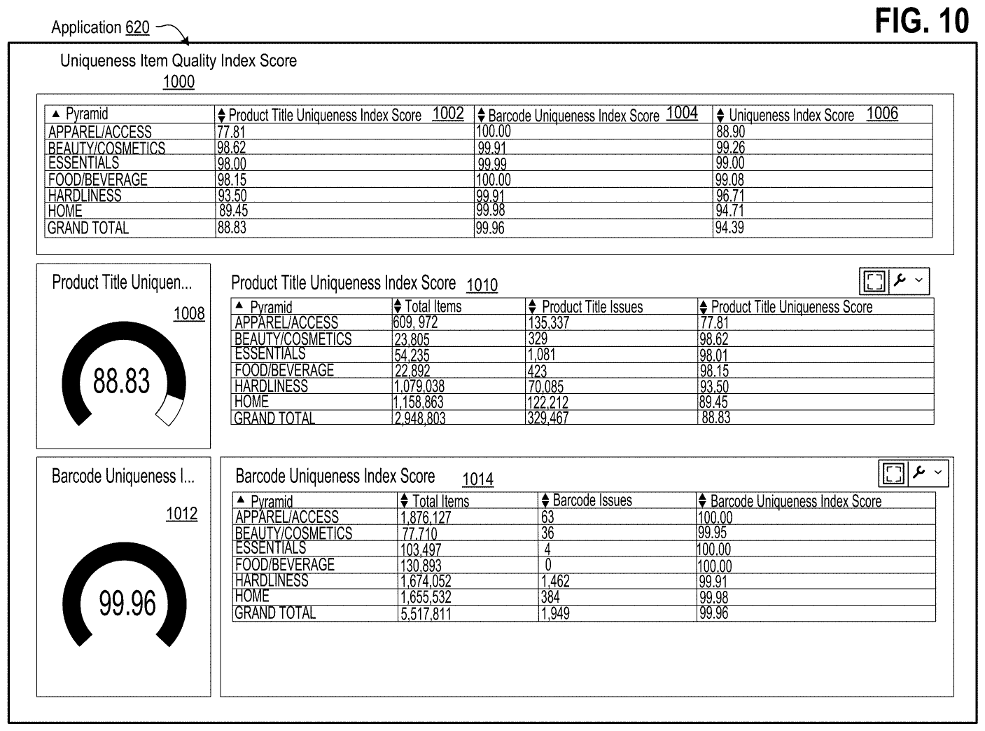

As depicted and described further in FIG. 10, the uniqueness score can be an aggregate of one or more aspects of the uniqueness metric that are assessed for the item listing. For example, the uniqueness score for the particular item listing can be a combination (e.g., average, aggregation) of a title uniqueness score and a barcode uniqueness score. As an illustrative example, the uniqueness score can be determined for a category of items based on identifying an average title uniqueness value as an aggregation of title uniqueness values for the item listings in the category, identifying an average barcode uniqueness value as an aggregation of barcode uniqueness values for the items in the category based on the corresponding item listing data, and averaging the average title uniqueness value and the average barcode uniqueness value to generate the uniqueness score for the particular category of items. The computer system can also generate output indicating the average title uniqueness value and the average barcode uniqueness value for the item category and/or multiple item categories. Refer to FIG. 10 for further discussion. In some implementations, the uniqueness score can be based on the uniqueness of other information included in an item listing including MTA fields such as item description. Such MTA information can be compared to MTA fields of other item listings to determine the uniqueness score in some implementations.

The computer system can determine the validity score (314) based on identifying whether the listing data includes legal or illegal values, an appropriate taxonomy (e.g., hierarchy), appears in a particular format, and/or follows business rules. The validity score can quantify whether a correct and appropriate taxonomy is used for the item listing such that the item can be easily found by consumers in the online retail environment. For example, a table can have an incorrect taxonomy of Furniture>Dining Room>Chair, and therefore can be assigned a low validity score. In this example, the system can automatically compare the taxonomy to other information in the item listing (e.g., title, description) to identify if the taxonomy may be incorrect and use this determination to calculate a relatively lower validity score for the item listing (or to lower a previously calculated validity score). The validity score can also quantify whether values (e.g., item type of a specific MTA value) that are no longer legal values in the computer system are used to describe the item in the item listing. For example, if “hand drums” is no longer a legal value to select in the computer system 202 (e.g., as defined by a values policy of the computer system, a source/supplier system, etc.) but item listings contain “hand drums” in their item descriptions (e.g., for example, because there was a time when “hand drums” was a legal value that was used by suppliers of the items), then each of those item listings can be assigned a low validity score (e.g., in relation to validity scores for item listings having legal taxonomy or other values). Thus, “hand drums” data can be reviewed by a relevant user or automatically reviewed by a computer system and removed/replaced with legal values. The validity score can be used to determine whether data can be removed from an item listing and/or whether the data is valid to be shared with and used by consumers in making purchase decisions and improving their experiences in the online retail environment.

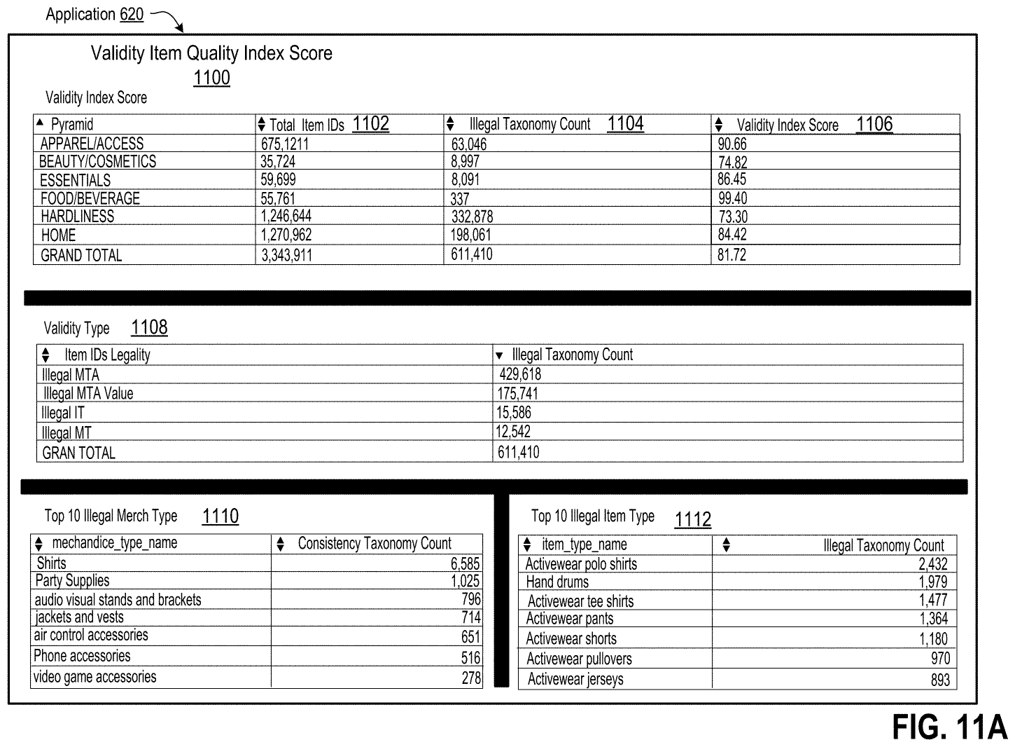

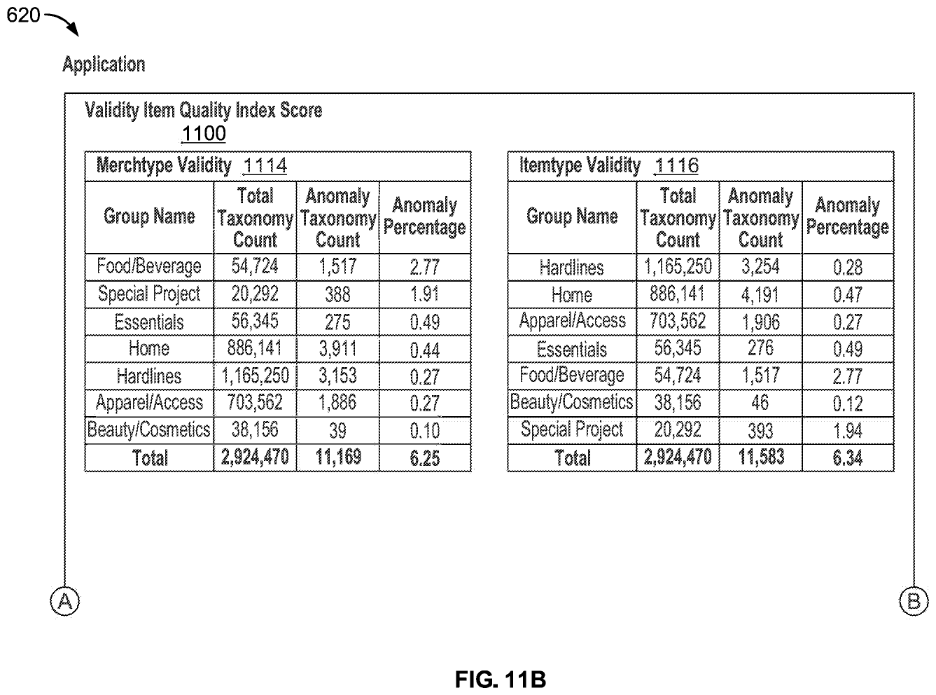

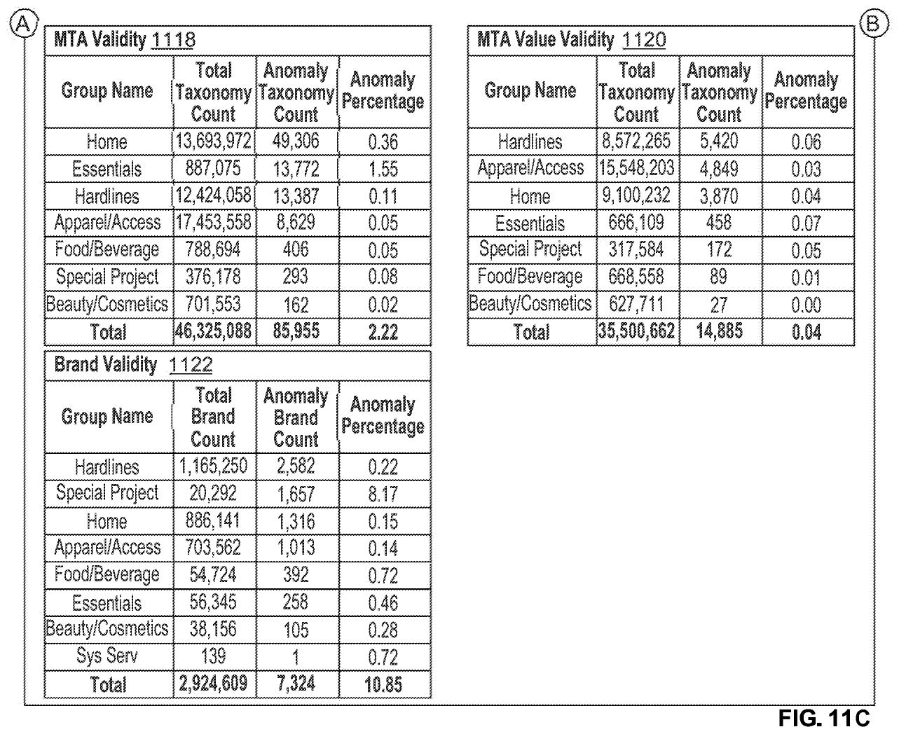

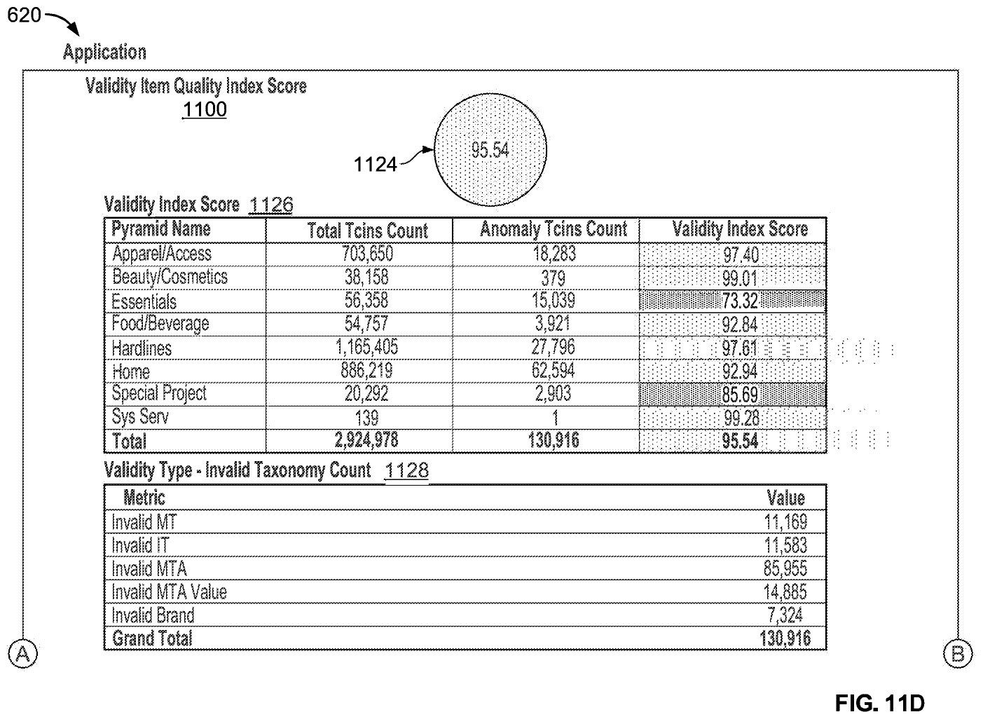

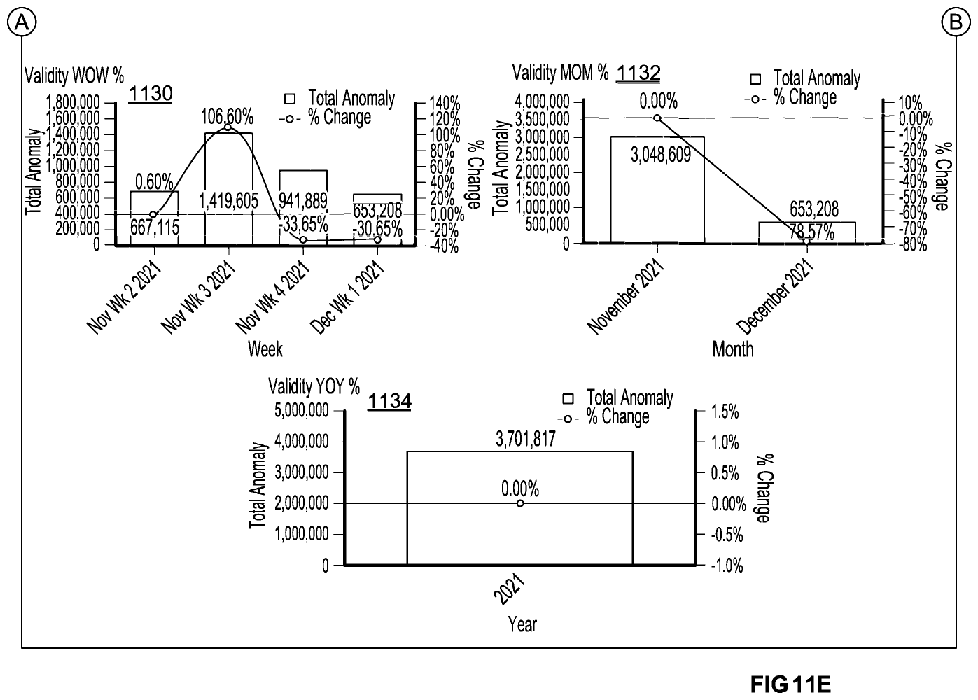

As depicted and described further in FIG. 11, the validity score can be an aggregate of one or more aspects of the validity dimension that are assessed for the item listing. For example, the validity score for the particular item listing can be a combination (e.g., average, aggregation) of a total quantity of unique item identifiers, and an illegal taxonomy count. The item identifiers can be used internally in the retail environment to uniquely identify each item. Thus, no two items in the retail environment may have the same item identifier. In some implementations, the item identifiers can be the same as supplier item identifiers and/or other types of identifiers that may be used throughout a supply chain and in the retail environment, including but not limited to barcodes, SKUs, and QR codes.

As an illustrative example, the validity score for a category of items can be determined based on identifying an average total item identifier (e.g., item ID) value as an aggregation of item identifier values for item listings in the category, identifying an average illegal taxonomy count as an aggregation of illegal taxonomy counts for the item listings, and averaging the average total item identifier value and the average illegal taxonomy count to generate the validity score. Total item identifiers can represent a total number of items that are being sold by the retail environment, whether in the physical retail environment and/or online, within each item category (e.g., pyramid).

The computer system can also generate output for an item category that indicates validity types for the item category and an illegal taxonomy count for each of the validity types. The computer system can identify a threshold quantity of illegal merchandise types for one or more item categories and generate output that includes at least the identified illegal merchandise types and illegal taxonomy counts that correspond to each of the identified illegal merchandise types. In some implementations, the computer system can also identify a threshold quantity of illegal item types for one or more item categories and generate output that includes at least the identified illegal item types and illegal taxonomy counts that correspond to each of the identified illegal item types. Refer to FIGS. 11A-E for further discussion.

The computer system can determine the consistency score (316) based on identifying whether information in the item listing data is consistent across data sets. The computer system can check whether values or other data match across data sets. For example, there can be an issue of consistency if the computer system identifies a title in the item listing data to include “&” while a title for the item from a supplier system uses “and.” This item listing can be assigned a low consistency score. As another example, warranty information for an item can be provided to the computer system from a source/supplier system, but may not be stored in the retail environment data store. When the item is loaded in the online retail environment in an item listing, the item listing does not pull the warranty information because the warranty information is not stored. As a result, the warranty information is not presented in the item listing even though it should be provided to consumers to facilitate their purchase decisions and experience. This item listing can be assigned a low consistency score for not including the warranty information across different data sets, thereby negatively impacting consumers' purchasing experiences.

Thus, the consistency score can quantify whether the item listing data is consistent across one or more different computing systems and/or data stores. Consistency of data can be measured between (1) source systems, (2) sources to the computer system, (3) retail environment data stores, (4) retail environment data stores to the computer system, (5) source systems to the retail environment data stores, and/or (6) the retail environment data stores to computing devices of relevant users and consumers. Consistency of data can be measured between one or more other data pipelines. Attributes such as merchandise type, item type, package dimensions, brands, etc. can be assessed throughout a data pipeline to generate the consistency score for a particular item listing and/or category of items. When attributes, or item listing data, appear the same across different data sets, systems, and/or pipelines, the item listing can be assigned a high consistency score. In some implementations, consistency can also be quantified across various items of a similar type and/or various items from a particular manufacturer, distributor, and/or supplier.

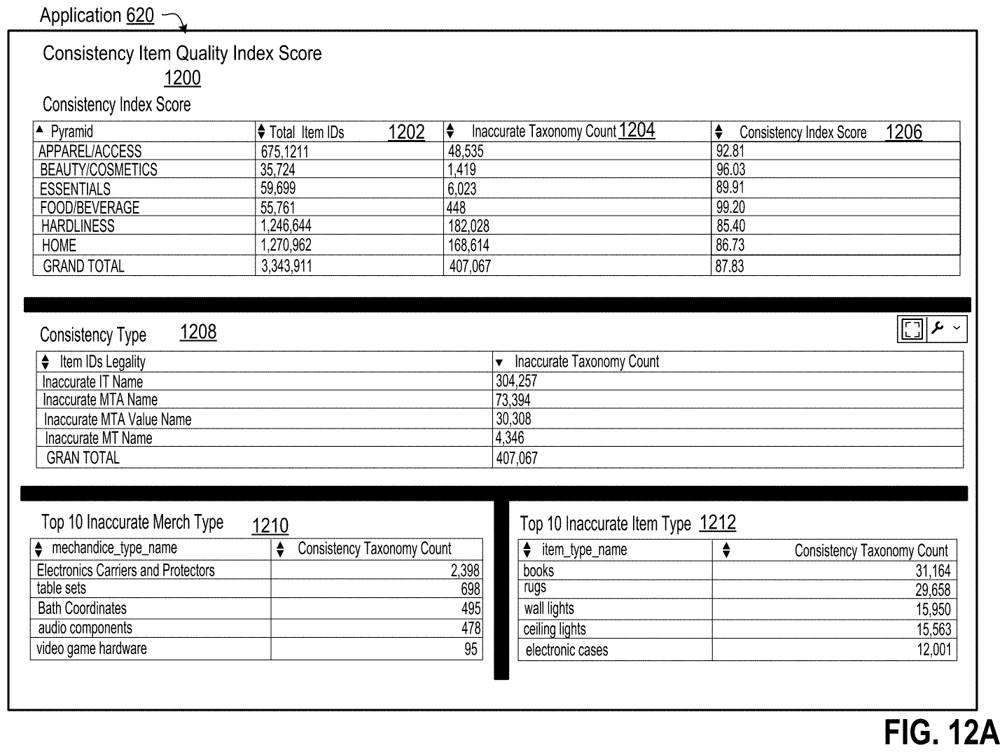

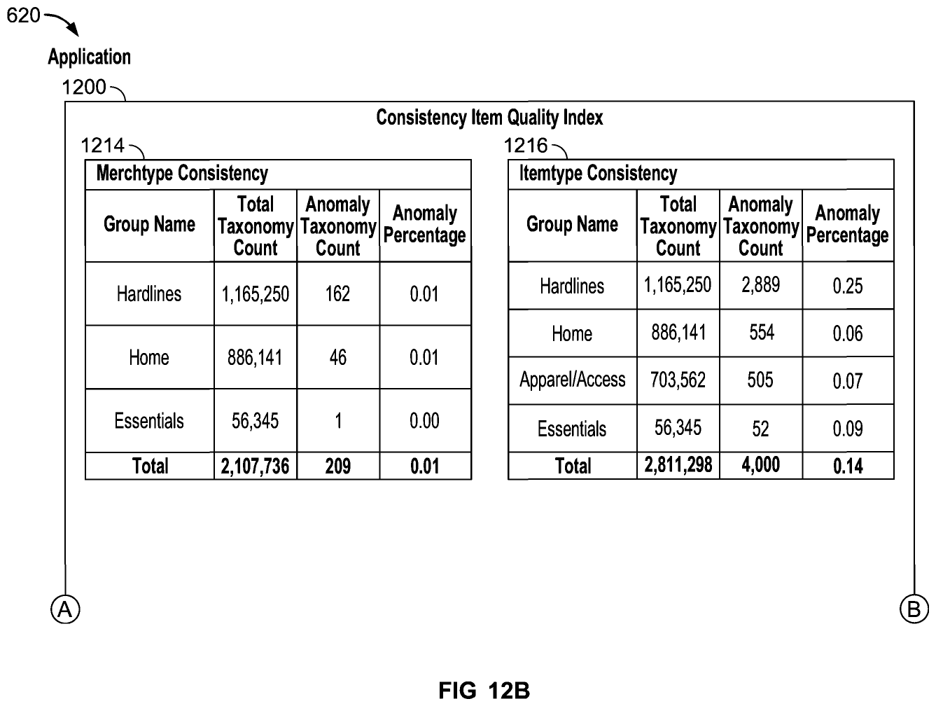

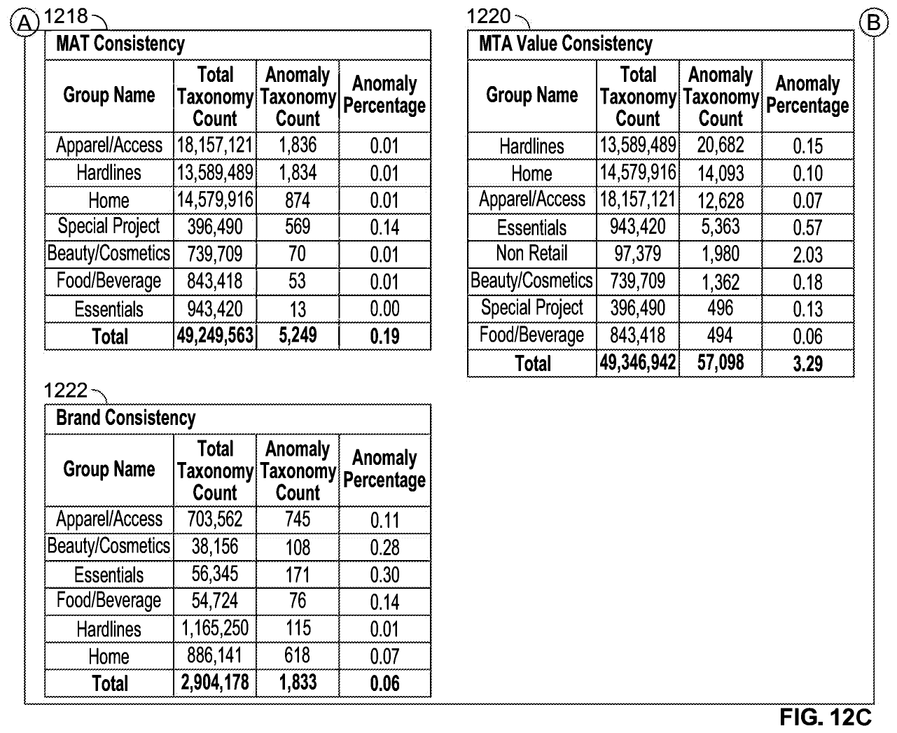

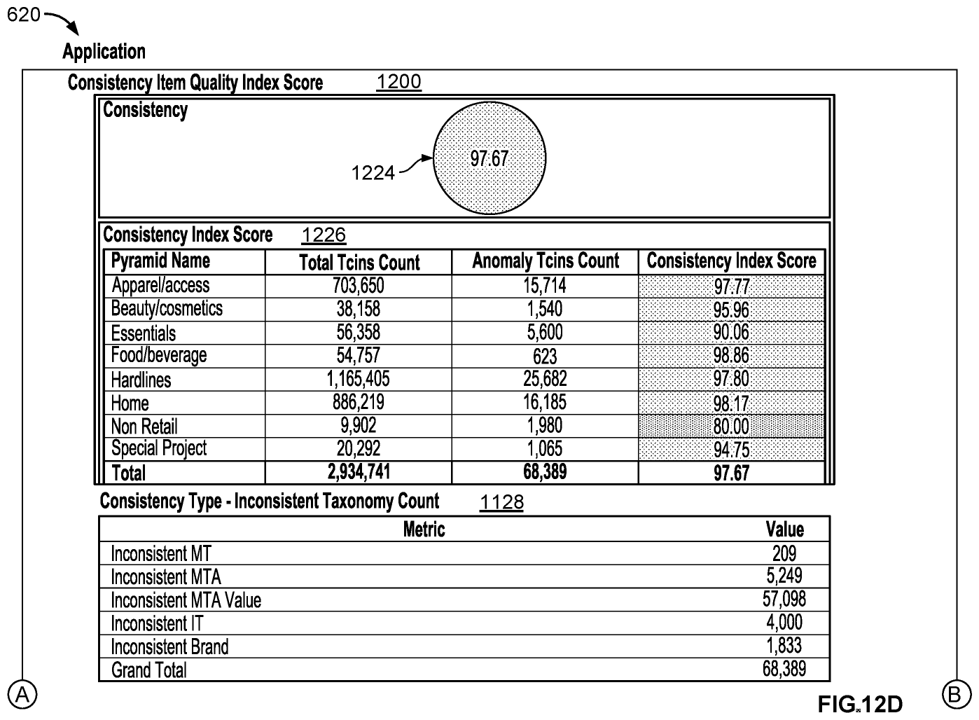

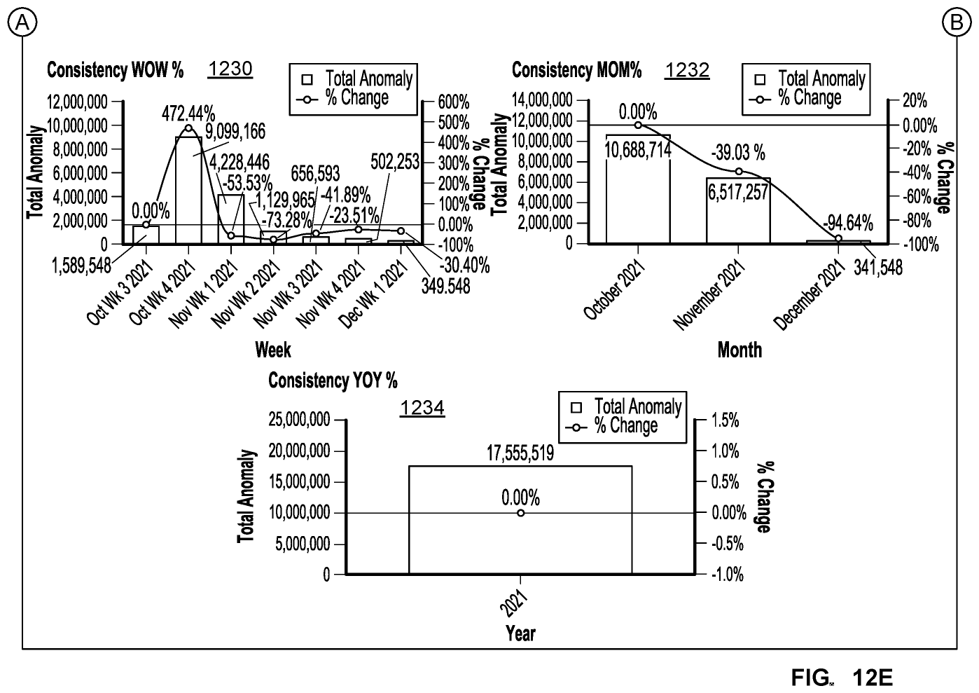

As depicted and described further in FIGS. 12A-E, the consistency score can be an aggregate of one or more aspects of the consistency metric. For example, the consistency score for the particular item listing can be a combination (e.g., average, aggregation) of a total item identifiers (e.g., IDs) and an inaccurate taxonomy count. As an illustrative example, the consistency score for a category of items can be determined based on identifying an average total item identifiers value as an aggregation of total item identification values for items in the category, identifying an average inaccurate taxonomy count as an aggregation of inaccurate taxonomy counts for the items, and averaging the average total item identifications value and the average inaccurate taxonomy count to generate the consistency score.

The computer system can also generate output indicating consistency types for an item category and an inaccurate taxonomy count for each of the consistency types. The computer system can, in some implementations, identify a threshold quantity of inaccurate merchandise types for an item category and generate output that includes at least the identified inaccurate merchandise types and consistency taxonomy counts that correspond to each of the identified inaccurate merchandise types. In yet some implementations, the computer system can identify a threshold quantity of inaccurate item types for an item category and generate output that includes at least the identified inaccurate item types and consistency taxonomy counts that correspond to each of the identified inaccurate item types. Refer to FIGS. 12A-E for further discussion.

Once the computer system determines the accuracy, completeness, timeliness, uniqueness, validity, and consistency scores, the computer system can determine a composite IQI score for the item listing in 318. The composite IQI score can be a combination of the scores determined in blocks 304-316. For example, the composite IQI score can be an average of the previously determined IQI scores for the particular item listing or category of items. The composite IQI score can also be a mean, aggregation, or other statistical computation of the previously determined IQI scores. The composite IQI score can therefore indicate an overall level of quality for the particular item listing and/or the category of items. Refer to FIG. 6 for further discussion about the composite IQI score.

Optionally, determining the composite IQI score can include weighting the determined IQI scores in 320. Then the computer system can average/aggregate the weighted IQI scores to generate the composite IQI score. Each of the previously determined IQI scores can be assigned a different weight. The weights can be determined based on the item type. Sometimes, one or more of the IQI scores can be more important for a particular item in comparison to another item. As an illustrative example, the accuracy score can be more important for clothing items than produce (e.g., accuracy in sizing, materials used, images, etc. can be more beneficial to consumers when making clothing purchasing decisions while accuracy in size, images, etc. of produce like carrots may be less important to consumers when making produce purchasing decisions) but the timeliness score can be more important for the produce than the clothing items (e.g., more recent information about where the produce originates from and it's “best by” date can impact consumer produce purchasing decisions while updated information about where a shirt is manufactured and shipped from can have less impact on consumer clothing purchasing decisions). Thus, the accuracy score can be weighted more heavily for clothing items rather than for produce and the timeliness score can be weighted more heavily for produce rather than the clothing items.

The weights can be dynamically and automatically updated over time depending on what IQI scoring metrics provide the most quality information and/or are most useful to consumer purchase decisions and shopping experiences. For example, the weights can be determined using a historic lookback feature of the computer system. The computer system can assess each of the IQI scoring dimensions for a particular item listing and/or category of items over a predetermined period of time. The historic lookback feature can be based on any combination of the IQI scoring dimensions, such as completeness and accuracy. The computer system can assess which IQI scoring metrics were the most important and/or had the most opportunity for improvement during the predetermined period of time.

For example, completeness and accuracy can be most important and/or a greatest opportunity for growth/improvement, and therefore weighted more heavily than the other four IQI scoring metrics (e.g., in combination, completeness and accuracy can make up 55% of the composite IQI score). In some implementations, the computer system can determine weights for each IQI score based on historical changes made to the item listing data of items in an item category as a result of the item listing data being assigned a low quality index score in the past. In some implementations, survey information, such as customer survey information can be used to determine the level of improvement for item listings based on weighted composite IQI scores and ITI scoring metrics can be reweighted based on such survey information. Moreover, in some implementations, weighting can be determined based on subject matter expertise, impact of particular types of issues on overall quality of a business, and/or new inputs that may be received and used to determine each of the IQI scoring metrics.

The computer system can also use machine learning techniques, algorithms, and/or models to dynamically and automatically modify the weights over time. In some implementations, the computer system can determine or otherwise update weights for one or more of the IQI scores based on applying a machine learning model to historic item listing data. The machine learning model can be trained using training data sets to correlate historic quality index scores with current trends in consumer purchase decisions and consumer feedback.

In some implementations, the accuracy score can be weighted within a first range of the composite IQI score for the item listing or the category of items. The completeness score can be weighted within a second range. The timeliness score can be weighted within a third range. The uniqueness score can be weighted within a fourth range. The validity score can be weighted within a fifth range. Finally, the consistency score can be weighted within a sixth range. As described herein, each of the ranges can vary depending on the item type and/or the category of items. For example, the first range can be greater than the second range, the second range can be greater than the third range, the third range can be equal to the fourth range, the third and fourth ranges can be greater than the sixth range, and the sixth range can be greater than the fifth range. As an illustrative example for a particular category of items, the accuracy score can be weighted 30% of the composite IQI score, the completeness score can be weighted 25%, the timeliness score can be weighted 15%, the uniqueness score can be weighted 15%, the consistency score can be weighted 10%, and the validity score can be weighted 5%.

The computer system can determine output for the item listing based on the composite IQI score (322). The output can be generated for the assessed item listing data for presentation on a display of a user computing device of a retail employee or other relevant user (e.g., the user device 204 in FIG. 2). The output can include visualizations, charts, and/or graphical depictions of the composite IQI score and/or the individual IQI scores for a particular item listing, category of items, and/or multiple categories of items (e.g., refer to FIGS. 6-12). The output can be used by the relevant user(s) to determine one or more updates that can be implemented to improve overall quality of the particular item listing, category of items, and/or multiple categories or items. Refer to FIGS. 6-12 for further discussion.

Optionally, the computer system can determine one or more operations to improve the composite IQI score and/or one or more of the individual IQI scores (324). The computer system can provide auto-remediation of item listing data. For example, the computer system can automatically update the item listing data. The computer system can also provide for automated flagging of low composite IQI scores and/or individual IQI scores across different data sets and/or computing systems. As a result, a variety of relevant users can be notified or otherwise made aware of the low scores such that the low scores can be addressed.

The operations can include instructions that, when executed by the computer system cause a notification to be sent to the user computing device (e.g., the user device 204) of the retail employee requesting updated information for the item in the item listing data or one or more items in one or more item categories from a supplier of the one or more items. In some implementations, the operations can include instructions that, when executed by the computing system, cause a notification to be sent to the user computing device of the retail employee requesting input from the retail employee for updated information for one or more items in one or more of the item categories.

The operations can also include automatically sending a notification to an item supplier if the composite IQI score and/or one or more of the IQI scores falls below some predetermined threshold range or value. For example, if the completeness IQI score for an item listing is below a predetermined threshold range, the computer system can automatically send an email to the item supplier (e.g., vendor) requesting the missing MTAs or other information for the item listing. In some implementations, the computer system can also measure whether the item supplier ignores the email and does not provide the requested information to update the item listing and improve the overall quality of the item listing (e.g., within a set time period from the time the email or other notification is sent).

In some implementations, the relevant user(s) can review the output, identify biggest failures or areas for improvement in a particular item listing and/or category of items, and determine what improvements can be made and/or preventative measures can be instituted to reduce such failures. Thus remediation efforts can be determined and executed. Sometimes, remediation efforts can include contacting item suppliers or other relevant supply chain users to determine what changes can and should be made to improve the IQI scores and/or the composite IQI score. This analysis can be performed for each of the IQI scoring metrics. This analysis can also be performed automatically or semi autonomously by the computer system or another computing system. In some implementations, the composite IQI score can be analyzed to determine what a particular merchandising team is doing right or wrong and how their actions impact overall quality of the item listing or category of items and consumer purchasing decisions and experiences.

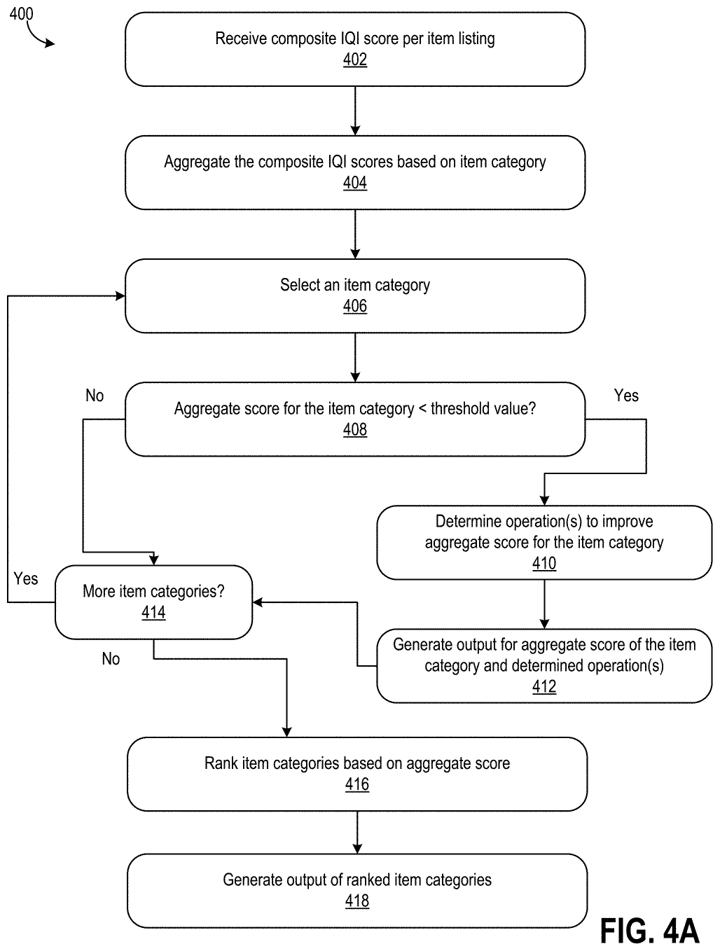

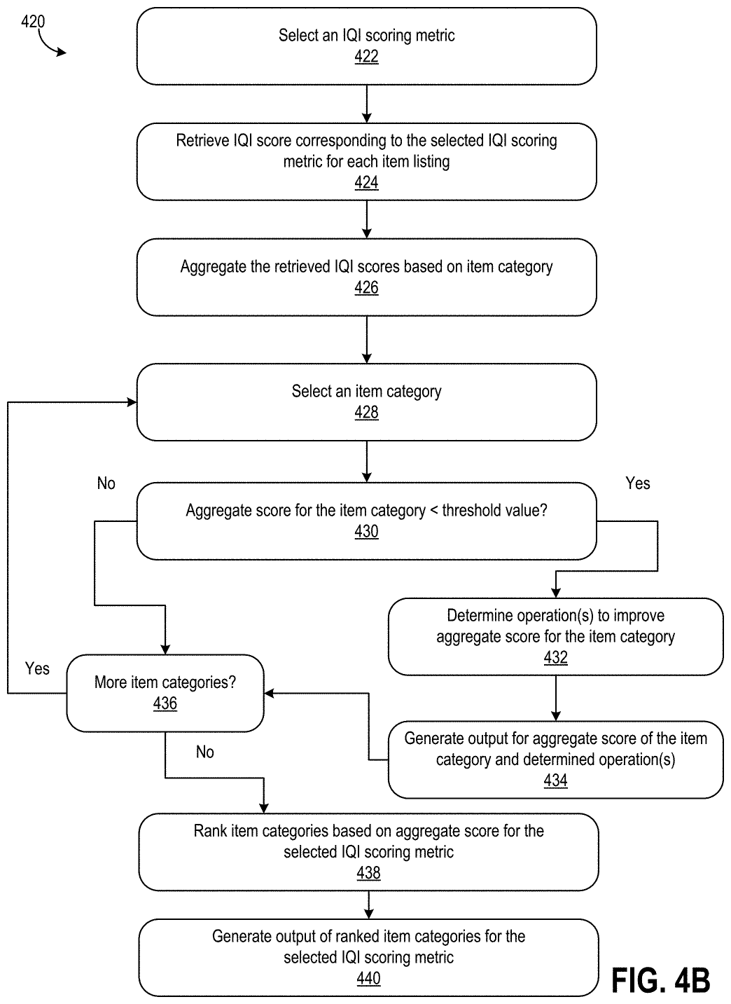

FIG. 4A is a flowchart of a process 400 for assessing composite IQI scores of different item categories. The process 400 can be performed to determine one or more changes that can be made to a particular category of items based on the composite IQI scores for item listings that comprise the category. The process 400 can be performed by the computer system 202. The process 400 or one or more blocks of the process 400 can also be performed by one or more other computing systems, devices, cloud-based services, and/or networks of devices and/or systems. For illustrative purposes, the process 400 is described from the perspective of a computer system.

Referring to the process 400, the computer system can receive the composite IQI score per each item listing in 402. For example, after the composite IQI scores are determined in the process 300 (e.g., refer to FIG. 3), the computer system can store the composite IQI scores in a data store. In the process 400, the computer system can then retrieve the composite IQI scores from the data store.

The computer system can aggregate the composite IQI scores based on item category (404). In other words, the computer system can identify all item listings of a particular item category, add together (e.g., sum) the composite IQI scores for those identified item listings, and then divide that summation by a total quantity of item listings for the particular item category. Thus, the computer system can determine an average of the composite IQI scores for the particular item category. The computer system can also aggregate the composite IQI scores for item listings of the particular item category using one or more other statistical functions, algorithms, and/or methods.

In 406, the computer system can select an item category. The computer system can determine whether the aggregate score for the item category is less than a predetermined threshold value (408). The predetermined threshold value can vary based on item category, type of items, and/or other features/attributes. In some implementations, the predetermined threshold value can be the same across multiple item categories. As an illustrative example, the predetermined threshold value can be a composite IQI score of 90.00. Thus, a composite IQI score that is below 90.00 can indicate lower quality item listings that should be reviewed and improved. A composite IQI score that is above 90.00 can indicate higher quality item listings that may not have to be reviewed or otherwise improved at a time of analysis.

If the aggregate score for the item category is less than the threshold value in 408, the computer system can determine one or more operations to improve the aggregate score for the item category (410). As described throughout this disclosure, the computer system can also automatically perform any of the determined operations. For example, the particular item category may not have enough item listings of sufficiently high quality to enhance a consumer's purchase decisions and experiences. Therefore, the aggregate score for the item category can be improved by determining and performing operations that can be intended to increase the quality levels of one or more item listings in the item category (such as updating titles of a group of item listings). The computer system can also generate output for the aggregate score of the item category and the determined operation or operations (412). Refer to blocks 322 and 324 in the process 300 of FIG. 3 for further discussion. The computer system can then proceed to block 414, as discussed further below.

Referring back to block 408, if the aggregate score for the item category is greater than the predetermined threshold value, the computer system can determine whether there are more item categories in 414. In other words, the particular item category has item listings of sufficient quality to benefit the consumers' purchase decisions and experiences. In some implementations, this means the particular item category has a sufficient quantity of item listings that do not have composite IQI scores below some predetermined threshold range or value. Thus, improvements, additions, or changes may not be required to item listings of the particular item category at the present time.

If there are more item categories to analyze, the computer system can return to block 406 and repeat the blocks 406-414 for each of the item categories. As a result, the computer system can determine whether any of the remaining item categories may require improvements, additions, or changes to improve the overall quality of those item categories. If there are no more item categories to analyze in block 414, the computer system can rank the item categories based on their aggregate score (416). The computer system can rank the item categories from highest to lowest aggregate score. In some implementations, the computer system can rank the item categories from lowest to highest aggregate score.

The computer system can then generate output of the ranked item categories in 418. Sometimes, the computer system can output a portion of the ranked item categories. For example, the computer system can output a top 10 item categories having the highest or lowest aggregate scores. In some implementations, it can be beneficial to output a portion of the ranked item categories having the lowest aggregate scores. These item categories can then be more quickly brought to the attention of and addressed by relevant users, such as retail employees. The ranked item categories can be outputted in a variety of ways, as described and depicted throughout this disclosure. For example, an item category having the lowest aggregate score can be visually outputted. Refer to FIG. 6 for an example output of one composite IQI score. As another example, multiple ranked item categories can be outputted in tables, charts, graphs, histograms, pie charts, and/or other visual depictions. In some implementations, a relevant user can select any one or more of the outputted item categories to view additional information about the selected item categories' composite IQI score and individual IQI scores. Refer to FIGS. 7-12 for additional discussion about outputting the individual IQI scores.

FIG. 4B is a flowchart of a process 420 for assessing one or more individual IQI scores for a particular item category. The process 420 can be performed to determine changes that can be made to a particular category of items based on a particular IQI score comprising the composite IQI score of the particular category. In other words, the process 420 can be used to determine changes that can be made to item listings in a particular item category based on an aggregate accuracy, consistency, timeliness, uniqueness, completeness, and/or validity score for that particular item category. As a result, relevant users can receive more specific information/notifications about what can and should be updated to improve quality of the item listings in one or more particular IQI scoring metrics.

The process 420 can be performed by the computer system 202. The process 420 or one or more blocks of the process 420 can also be performed by one or more other computing systems, devices, cloud-based services, and/or networks of devices and/or systems. For illustrative purposes, the process 420 is described from the perspective of a computer system.

Referring to the process 420, the computer system can select an item quality index (IQI) scoring metric in 422. As described throughout this disclosure, the IQI scoring metrics can include: accuracy, completeness, uniqueness, timeliness, validity, and consistency. The computer system can then retrieve an IQI score corresponding to the selected item quality index scoring metric for each item listing (424). The IQI scores can be retrieved from a data store, as described throughout this disclosure.

The computer system can aggregate the retrieved IQI scores based on item category in 426. In other words, the computer system can group the IQI scores based on item category. For each item category, the computer system can determine an average and/or mean of the grouped IQI scores. Therefore, the computer system can determine an aggregate IQI score associated with the particular IQI scoring metric for each item category.

In 428, the computer system can select an item category. Then, the computer system can determine whether the aggregate IQI score for the item category is less than a predetermined threshold value (430). The predetermined threshold value can be determined by a relevant user and/or the computer system. The predetermined threshold value can also be different for each of the IQI scoring metrics. Moreover, in some implementations, the predetermined threshold value can be different based on the item category. For example, for a category of clothing, an accuracy IQI score may be more important than a timeliness IQI score. The accuracy IQI score can have a higher predetermined threshold value than the timeliness IQI score. On the other hand, for a category of produce, the accuracy IQI score can be less important than the timeliness score. Thus, the accuracy IQI score can have a lower predetermined threshold value than the timeliness score for the produce category.

If the aggregate IQI score for the item category is less than the threshold value, the computer system can determine one or more operations that can be performed to improve the aggregate score for the item category (432). As described throughout, the computer system can automatically perform the determined operations. For example, if the aggregate accuracy IQI score for the clothing category falls below the threshold value, the computer system can determine that one or more suppliers of clothing items should be contacted to provide updated information about their clothing items. The computer system can automatically transmit messages to the suppliers, prompting them for new/updated information. In some implementations, when the suppliers respond with the new/updated information, the computer system may quickly, efficiently, and automatically update the corresponding clothing listings with that information. One or more other operations can be determined, as described throughout this disclosure. For example, the system can flag particular suppliers as having below average (or below threshold value) IQI scores in general or on average such that processes related to the flagged suppliers can be improved to improve IQI scores for items supplied by those suppliers in general. The computer system can then generate output for the aggregate score of the item category and the determined operation(s) in 434, as described throughout this disclosure. The computer system can then proceed to block 436.

Referring back to block 430, if the aggregate score for the item category is greater than the threshold value, the computer system can determine whether there are more item categories to analyze in 436. In other words, the computer system can determine that the particular item category may not require updates at a present time in order to improve an aggregate IQI score for a particular IQI scoring metric. In the clothing category example, if the accuracy IQI score is greater than the threshold value, the computer system can determine that the clothing item listings are of sufficient quality to improve consumer purchase decisions and experiences. Thus, the computer system can determine that the clothing category does not require any updates or modifications at the present time. The computer system can proceed to review one or more other item categories.

If there are more item categories to analyze, the computer system can return to block 428 and repeat blocks 428-436 until all item categories are analyzed for the selected item quality index scoring metric. If there are no more item categories to analyze, the computer system can rank the item categories based on their respective aggregate scores for the selected IQI scoring metric (438). As described in reference to the process 400 in FIG. 4A, the item categories can be ranked from lowest to highest aggregate score for the selected IQI scoring metric. The computer system can also generate output of the ranked item categories for the selected IQI scoring metric in 440. As described herein, a portion of the ranked item categories can be presented to the relevant user at the user's computing device (e.g., the user device 204). For example, a top 10 ranked item categories can be outputted, thereby bringing the relevant user's attention to addressing and improving those particular item categories.

Moreover, the process 420 can be performed to assess each item category under each of the IQI scoring metrics (accuracy, completeness, uniqueness, timeliness, validity, and consistency).

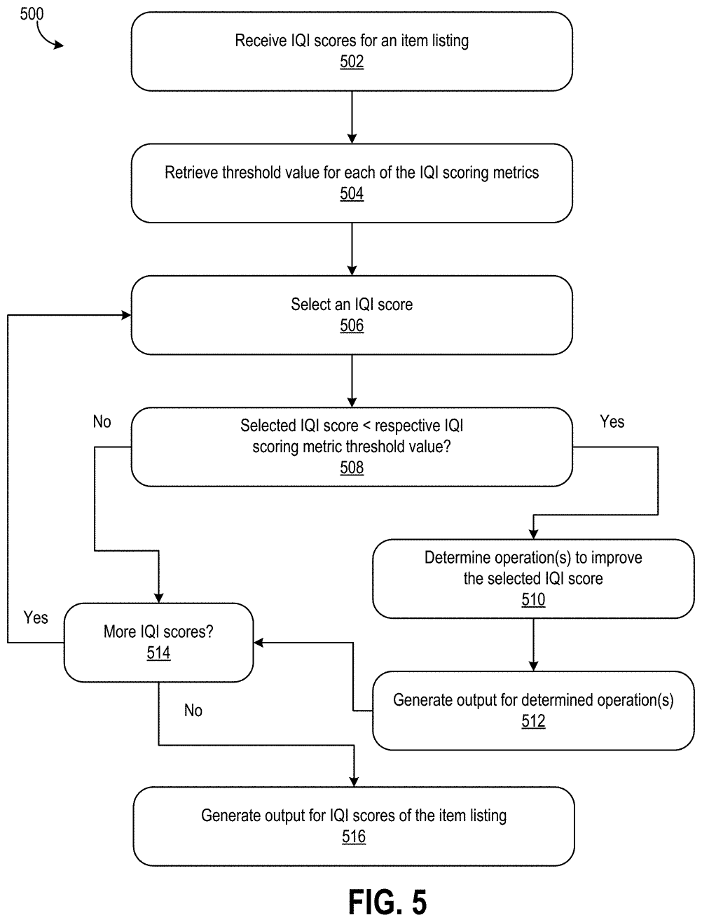

FIG. 5 is a flowchart of a process 500 for assessing one or more individual IQI scores for a particular item listing. The process 500 can be performed to determine changes that may be applied to the particular item listing based on the item listing's IQI scores. The process 500 can be performed by the computer system 202. The process 500 or one or more blocks of the process 500 can also be performed by one or more other computing systems, devices, cloud-based services, and/or networks of devices and/or systems. For illustrative purposes, the process 500 is described from the perspective of a computer system.

Referring to the process 500, the computer system can receive IQI scores for a particular item listing in 502. The computer system can also retrieve IQI scores for the particular item listing from a data store, as described herein. In some implementations, the process 500 may start once a relevant user at a user device (e.g., the user device 204) provides input at the user device requesting to assess a particular item listing.

In 504, the computer system can retrieve a threshold value for each of the IQI scoring metrics. As described herein (e.g., refer to FIG. 4B), each of the IQI scoring metrics (accuracy, completeness, uniqueness, timeliness, validity, and consistency) can have a different threshold value and/or range. Moreover, the threshold value and/or range can vary depending on a type of item in the item listing.

The computer system can then select an IQI score of the item listing in 506. The computer system can determine whether the selected IQI score is less than a respective IQI scoring metric threshold value (508). For example, the computer system can select an accuracy IQI score for the item listing and compare that score to a threshold value that corresponds to the accuracy IQI scoring metric for the particular type of item in the item listing. If the selected IQI score is less than the threshold value, the computer system can determine one or more operations to improve the selected IQI score in 510. As described in reference to the processes 400 and 420 in FIGS. 4A-B, if the score is less than the threshold value, then the item listing may be improved by addressing issues with regards to the particular IQI scoring metric. For example, if the item listing's accuracy IQI score is less than the threshold value for the accuracy IQI scoring metric, the computer system can determine operations, such as contacting a supplier of the item in the listing that can result in improving the item listing's accuracy. As described throughout this disclosure, the computer system can automatically perform any of the determined operations. The computer system can also generate output for the determined operation(s) (512). Refer to FIGS. 2-4 for further discussion about determining and outputting the operations. The computer system can then proceed to block 514.

Referring back to block 508, if the selected IQI score is greater than the threshold value, the computer system can determine whether there are more IQI scores in block 514. In other words, the computer system determines that the particular item listing does not have to be improved at a present time based on the IQI scoring metric that is being assessed. The computer system can proceed to determine whether the item listing should be improved based on any of the other IQI scoring metrics (accuracy, completeness, uniqueness, timeliness, validity, and consistency).

If there are more IQI scores to analyze, the computer system can return to block 506 and repeat the blocks 506-514 for each of the remaining IQI scores. For example, the process 500 can be performed 6 times, once for each of the 6 IQI scoring metrics (accuracy, completeness, uniqueness, timeliness, validity, and consistency). In some implementations, the process 500 can be performed in parallel, at a same time, for all of the IQI scoring metrics of the particular item listing. In yet some implementations, the process 500 may only be performed for a selected portion of the IQI scoring metrics. For example, the relevant user may decide to assess the item listing based on fewer than all of the IQI scoring metrics, such as uniqueness, validity, and consistency. Retail environment policies can, in some implementations, dictate whether an item listing is assessed based on all the IQI scoring metrics or a selected group of the IQI scoring metrics. Whether the item listing is assess based on all or a selected group of the IQI scoring metrics can also depend on a type of item in the listing and/or a category of items that the item listing is associated with. Finally, if there are no more IQI scores to analyze for the particular item listing in 514, the computer system can generate output for the IQI scores of the item listing in 516. Refer to FIGS. 2-4 for further discussion about generating the output.

FIG. 6 illustrates a user interface (such as a user interface of an employee computer terminal) displaying an example composite IQI score 600. The composite IQI score 600 can be visually depicted and presented in a graphical user interface of an application 620 or other program, software, and/or service. The application 620 can be loaded and executed at a user device of a relevant user, such as the user device 204.

Here, the composite IQI score 600 is depicted as a semi-circle, similar to a donut pie chart. The composite IQI score 600 for the particular item listing or item category in FIG. 6 is 87.17 out of 100. Thus, the score 600 is shown as filling almost the full semi-circle. More precisely, 87.17% of the semi-circle is filled in or otherwise shaded in a first indicia, such as a color. A remaining portion of the semi-circle, or 12.83% of the semi-circle, is shaded in a second indicia, such as a color. Here, the first indicia can be yellow and the second indicia can be grey. The second indicia can remain the same for all visual depictions of the composite IQI score 600 and individual IQI scores. The first indicia, on the other hand, can dynamically change, depending on the composite IQI score 600. For example, if the composite IQI score 600 is within a first range, the first indicia can be red. If the composite IQI score 600 is within a second range that is greater than the first range, the first indicia can be yellow. If the composite IQI score 600 is within a third range that is greater than both the first and second ranges, then the first indicia can be green. Thus, the higher the composite IQI score 600, the higher the quality of the corresponding item listing or item category, and the less attention that the item listing or item category may require. A composite IQI score that is visually depicted in a red color may indicate that the composite IQI score 600 is low and that the corresponding item listing or item category is of such low quality that it requires more and/or immediate attention.

As shown in FIG. 6, the individual IQI scores that comprise the composite IQI score 600 can also be depicted. In some implementations, the relevant user can click on or otherwise select any of the individual IQI score visual depictions to view additional information about such scores. Depicted herein are an accuracy IQI score 602, a completeness IQI score 604, a timeliness IQI score 606, a uniqueness IQI score 608, a validity IQI score 610, and a consistency IQI score 612. Each of the individual IQI scores 602-612 are depicted similarly to the composite IQI score 600, as semi-circles with shaded portions in the first and second indicia. Moreover, the composite IQI score 600 is an average (e.g., aggregation) of the individual IQI scores 602-612.

Here, the accuracy IQI score 602 for the particular item listing or item category is 84.93. The score 602 can fall within the second range for the accuracy IQI scoring metric. Thus, 84.93% of the semi-circle is shaded in yellow. The completeness IQI score 604 for the particular item listing or item category is 81.11. The score 604 can fall within the second range for the completeness IQI scoring metric. Thus, 81.11% of the semi-circle is shaded in yellow. The timeliness IQI score 606 for the particular item listing or item category is 93.26. The score 606 can fall within the third range for the timeliness IQI scoring metric. Thus, 93.26% of the semi-circle is shaded in green. The uniqueness IQI score 608 for the particular item listing or item category is 94.39. The score 608 can fall within the third range for the uniqueness IQI scoring metric. Thus, 94.39% of the semi-circle is shaded in green. The validity IQI score 610 for the particular item listing or item category is 81.72. The score 610 can fall within the second range for the validity IQI scoring metric. Thus, 81.72% of the semi-circle is shaded in yellow. Finally, the consistency IQI score 612 for the particular item listing or item category is 87.83. The score 612 can fall within the second range for the consistency IQI scoring metric. Thus, 87.83% of the semi-circle is shaded in yellow.

As described throughout this disclosure, the first, second, and third ranges can vary depending on one or more of a type of item in the item listing or item category and each of the IQI scoring metrics. Provided below are example first, second, and third ranges for a particular item category, based on the IQI scoring metrics. The completeness metric can have a first range of <70 for the completeness IQI score, a second range of 85-70, and a third range of >85. The accuracy metric can have a first range of <70 for the accuracy IQI score, a second range of 90-70, and a third range of >90. The uniqueness metric can have a first range of <90 for the uniqueness IQI score, a second range of 99-90, and a third range of >99. After all, each item should be uniquely identified and thus have a score of 100. However, the ranges for the uniqueness metric can leave room for exceptions, such as dynamic assortments that may not be prioritized by a merchandising team or other relevant stakeholders in the supply chain. The timeliness metric can have a first range of <70 for the timeliness IQI score, a second range of 90-70, and a third range of >90. Item data should be current and up to date (e.g., updated within a past 0-3 months, which is represented by the third range), but the ranges for the timeliness metric can leave room for timeliness that may be related to seasonal items, such as Christmas trees, and other carry-forward items. Carry-forward items are existing items that a merchant/buyer chooses to keep in an assortment. When merchants/buyers plan their assortments, they may consider existing items in their assortments along with new item offerings from vendors. For example, particular detergent brands can be carry-forward items and thus may be consistently offered within a retail environment's assortment. The validity metric can have a first range of <70 for the validity IQI score, a second range of 90-70, and a third range of >90. Finally, the consistency metric can have a first range of <70 for the consistency IQI score, a second range of 90-70, and a third range of >90. As described herein, one or more other ranges for each of the IQI scoring metrics can be determined and applied.

FIG. 7 illustrates a user interface (such as a user interface of an employee computer terminal) displaying an example accuracy IQI score 700, which can be one of the individual IQI scores that comprises the composite IQI score. The accuracy IQI score 700 measures how accurate information is across different systems for a particular item listing or item category. The accuracy IQI score 700 can be depicted in the application 620, described in FIG. 6. A relevant user can be presented with the accuracy IQI score 700 and/or the user can select the accuracy IQI score 602 in FIG. 6 to be directed to a new GUI display shown in FIG. 7.

The accuracy IQI score 700 can be based on averaging one or more individual scores. For example, the score 700 can be an average of item certification, product title, and package metric scores. Information such as guest feedback, reviews, and tickets for inaccuracies in item listings can also be used to adjust or otherwise determine the accuracy IQI score 700 for a particular item, item category, and/or group of categories.

The accuracy IQI score 700 can be depicted as a table indicating item certification score 702, item title score 704, and aggregate accuracy IQI score 706 per item category. The accuracy IQI score 700 can also be depicted as an item certification score 708, which can be visually outputted in a semi-circle as described in reference to FIG. 6. The accuracy IQI score 700 can also include an item certification score table 710 and/or a top 10 item certification failures table 712. One or more additional or fewer tables and/or visual or graphical depictions can also be outputted for the accuracy IQI score 700.

In this example, apparel and accessories has an item certification score 702 of 80.05 and a product title score 704 of 97.18. When these scores are averaged, the apparel and accessories category has an aggregate accuracy score 706 of 88.61, which puts this category in the second range (e.g., refer to FIG. 6 for discussion on the first, second, and third ranges). Beauty and cosmetics, on the other hand, has an item certification score 702 of 61.66 and a product title score 704 of 98.18. When these scores are averaged, the beauty and cosmetics category has an aggregate accuracy score 706 of 79.92 which puts this category in the second range as well. For all the item categories listed in FIG. 6, a grand total item certification score 702 is 75.57 (e.g., an average of the score 702 for each of the listed categories), a grand total product title score 704 is 94.29, and a grand total aggregate accuracy score 706 is 84.93.

One or more of the certification score 702, product title score 704, and aggregate accuracy score 706 for each of the item categories can be represented in different indicia (e.g., colors) in the table. For example, scores 702, 704, and/or 706 that are above a first threshold level can be depicted in a first color, such as green. Scores 702, 704, and/or 706 that are below a second threshold level can be depicted in a second color, such as red. And, scores 702, 704, and/or 706 that are between the first and second threshold levels can be depicted in a third color, such as yellow. The green color can indicate that the scores 702, 704, and/or 706 are high enough to provide sufficient quality for the item category and/or item listing. The yellow color can indicate that the scores 702, 704, and/or 706 should be addressed/monitored to improve quality of the item category and/or item listing. Finally, the red color can indicate that the scores 702, 704, and/or 706 must be addressed rather soon in order to improve the quality of the item category and/or item listing. One or more other indicia can be used.

In the example of FIG. 7, the certification scores 702 for all of the item categories except for beauty/cosmetics and food/beverage can be represented in yellow colored cells in the table. The certification scores 702 for beauty/cosmetics and food/beverage can be represented in red colored cells in the table. Thus, these scores can be more easily identified and addressed by a relevant user. The product title scores 704 for all of the item categories except for food/beverage can be represented in green colored cells in the table. The product title score 704 for food/beverages can be represented in a yellow colored cell. Finally, the aggregate accuracy scores 706 for all of the item categories can be represented in yellow colored cells in the table.

The item certification score 708 visually depicts the grand total item certification score 702, demonstrating that the item certification for all the listed categories is in need of improvement (e.g., the semi-circle is 75.57% shaded in the first indicia, which represents the second range). In some implementations, the grand total product title score 704 and/or the grand total aggregate accuracy score 706 can be visually depicted in a similar way to provide the relevant user with a view of what quality improvements can and/or should be made with regards to the accuracy metric.

The item certification score 708 is also broken down and depicted in another view: the item certification score table 710. The table 710 lists, for each item category, total item identifiers, certification failures, valor failures, guest feedback tickets, and aggregate item certification score. The table 710 also depicts grand totals for each of the total item identifiers, certification failures, valor failures, guest feedback tickets, and aggregate item certification score. The valor failures can be based on review of image data of a particular item and/or reviews of the particular item in a physical retail environment (e.g., store). The table 710 can be beneficial to provide the user with another, more granular view of the item certification score 708. The user can therefore use the table 710 to identify inaccuracies in each of the item categories and determine which of the item categories to address. For example, the user may decide to address accuracy in the beauty and cosmetics category as well as the food and beverage category, both of which have aggregate item certification scores in the first range.

Similar to the values in the table described above, values in the certification scores table 710 can also be represented in different indicia, such as colors. For example, certification scores for every item category except beauty/cosmetics and food/beverage can be represented in yellow colored cells. The certification scores for beauty/cosmetics and food/beverage can be represented in red colored cells, thereby drawing a relevant user's attention to review certification information for those two categories.

The top 10 item certification failures 712 can provide another view of the item certification score 708. The table 712 can be beneficial to provide the user with another, more granular view of particular item certification failures that were identified. The user can therefore determine more specific operations that can be performed to remedy the identified failures. The table 712 can depict attributes, attribute types, and total item identifiers.

Although not depicted, the application 620 can also include one or more selectable options to perform operations based on the outputted information. For example, the application 620 can present options to contact one or more item suppliers, manually update information in one or more item listings, etc., as described throughout this disclosure.

FIG. 8 illustrates a user interface (such as a user interface of an employee computer terminal) displaying an example completeness IQI score 800, which can be one of the individual IQI scores that comprises the composite IQI score. The completeness IQI score 800 can measure/quantify how much information in an item listing is filled out/completed. The completeness IQI score 800 can be depicted in the application 620, described in FIG. 6. A relevant user can be presented with the completeness IQI score 800 and/or the user can select the completeness IQI score 604 in FIG. 6 to be directed to a new GUI display shown in FIG. 8.

The completeness IQI score 800 can measure data completeness of merchant type attributes (MTAs) since an item taxonomy/hierarchy can be dynamic and used to drive consumer purchase decisions and experiences. The completeness IQI score 800 can also measure content completeness (e.g., image, video, size chart, etc.), which can be defined by item content guidelines of the retail environment, suppliers, vendors, or other relevant stakeholders. Moreover, the completeness IQI score 800 can be based on item suppliers' overall content effectiveness (e.g., whether the content provided by suppliers includes images, videos, written text, and other elements that drive consumer experiences) to determine whether an item listing is missing any components. One or more of these attributes can be required or optionally weighted in calculating the completeness IQI score. As an illustrative example, MTA can account for 50% of the completeness IQI score. As another example, MTA can account for 85% of the completeness IQI score and one or more other attributes can be weighted into the remaining 15% of the completeness IQI score.

As described in reference to FIGS. 6-7, the completeness IQI score 800 can be depicted as a semi-circle that is filled in with the first indicia in a percentage that corresponds to the completeness IQI score 800. In the example of FIG. 8, the completeness IQI score 800 for the particular item category is 80.96. Thus, 80.96% of the semi-circle is filled in with the first indicia. Here, the first indicia is yellow because the score 800 falls within the second range.

The score 800 can also be depicted in a completeness score table 802. For each item category, the table 802 can list required MTA score 804 (e.g., data completeness), content score 806 (e.g., content completeness), and aggregate completeness score 808. The required MTA score 804 can be determined by dividing a quantity of item listings missing MTAs/information from a total quantity of item listings in the particular item category. The aggregate completeness score 808 can be an average of the scores 804 and 806. In some implementations, the scores 804 and 806 can also be weighted and then averaged to determine the aggregate completeness score 808 for the particular item category. In some implementations, a quantity of item listings that meet data completeness guidelines (e.g., have the required MTAs) can be weighted 50% then added to the content score 806 in order to determine the aggregate completeness score 808 for the particular item category.

The table 802 can also present, for all of the item categories combined, a grand total required MTA score 804, a grand total content score 806, and a grand total completeness score 808. The grand total completeness score 808 is depicted as the completeness IQI score 800.

One or more of the required MTA score 804, the content score 806, and the aggregate completeness score 808 for each of the item categories can be represented in different indicia (e.g., colors) in the table. Refer to FIG. 7 for further discussion about example indicia, such as green, yellow, and red colored table cells. In the example of FIG. 8, the required MTA score 804 for apparel/accessories, essentials, and hardlines can be represented in yellow colored cells in the table. The required MTA score 804 for beauty/cosmetics, food/beverage, and home categories can be represented in green colored cells in the table. Thus, a relevant user can more easily identify the yellow colored cells as particular areas to improve quality in the corresponding item categories. The content scores 806 for all of the item categories except for beauty/cosmetics and essentials can be represented in yellow colored cells in the table. The content scores 806 for beauty/cosmetics and essentials can be represented in green colored cells. Finally, the aggregate completeness scores 808 for all of the item categories except apparel/accessories and hardlines can be represented in green colored cells in the table. The aggregate completeness scores 808 for apparel/accessories and hardlines categories can be represented in yellow colored cells, thereby drawing the relevant user's attention to review those categories.

Grand total required MTA score 810 can also be outputted and visually depicted in a shaded semi-circle. Moreover, the required MTA score 804 can be expanded and displayed in a table 812. For each item category, the table 812 can output total item identifiers, item identifiers missing requirements, missing required MTAs, and required MTA index score. Thus, the table 812 can depict a more granular view of components that are assessed and scored to determine the required MTA score 804 for each item category. The table 812 can be beneficial to assist the relevant user in deciding which of the item categories should be addressed based on their data completeness.

Similar to the table 802, values in the table 812 can be represented in different indicia (e.g., colors) to indicate whether the item categories need to be addressed at the present time. For example, the required MTA scores for apparel/accessories, essentials, and hardlines are represented in yellow colored cells, which indicates that these categories should probably be addressed at the present time to improve data completeness. The required MTA scores for beauty/cosmetics, food/beverage, and home are represented in green colored cells in the table 812, which indicates these categories do not need to be addressed at the present time.

Table 814 can also be presented in the application 620 to output top 10 attributes having missing required MTAs. The table 814 can be used by the user to determine which attributes to address/complete to improve the completeness IQI score 800.

Moreover, table 816 can be presented in the application 620 to output top 10 vendors (e.g., suppliers) who are related to the missing required MTAs. The table 816 can be used by the user and/or the computer system to determine which vendors should be contacted and informed that information is missing.

Although not depicted, the application 620 can also include one or more selectable options to perform operations based on the outputted information. For example, the application 620 can present options to contact one or more item vendors, manually update information in one or more item listings, etc., as described throughout this disclosure.

FIG. 9 illustrates a user interface (such as a user interface of an employee computer terminal) displaying an example timeliness IQI score 900, which can be one of the individual IQI scores that comprises the composite IQI score. The timeliness IQI score 900 can measure/quantify how frequently data is updated and how recent item listing data has been updated. The timeliness IQI score 900 can provide insight into why certain item listings are frequently or infrequently updated. Thus, the timeliness IQI score 900 can provide insight into why certain item listings are frequently or infrequently updated. The timeliness IQI score 900 can be depicted in the application 620, described in FIG. 6. A relevant user can be presented with the timeliness IQI score 900 and/or the user can select the timeliness IQI score 606 in FIG. 6 to be directed to a new GUI display shown in FIG. 9.

The timeliness IQI score 900 can be outputted as a shaded in semi-circle as depicted and described in reference to FIGS. 6-8. In this example, the timeliness IQI score 900 is 90.77. As a result, 90.77% of the semi-circle is shaded in the first indicia, which is a green color. The green color can represent the third range. This score demonstrates that 90.77% of all item listings have been updated in a past 0 to 3 months.

A table 902 can also be presented in the application 620, which depicts an item-level review of timeliness. Thus, the table 902 depicts, for each item, the item's identifier, a category that the item is part of, update history, a last time data associated with the item listing and/or data in the table 902 was refreshed, and a last date when an update was made to the item listing. The table 902 can be used by the relevant user to determine which particular item listings may need to be reviewed and updated to improve the timeliness IQI score 900.

A table 904 can also be presented in the application, which depicts a category-level review of timeliness. Thus, the table 904 depicts, for each item category, an update history and a quantity of distinct item identifiers. The table 904 can be used by the relevant user to determine which item categories may need to be further reviewed and updated to improve the timeliness IQI score 900.

Although not depicted, the application 620 can also present information such as a percentage of item identifiers that have been updated within a last 0-3 months/3-6 months, 6-12 months/12+ months, etc. This percentage can be outputted per item category, in tables, shaded in semi-circles, and/or one or more other visual depictions described in reference to FIGS. 6-12. The application 620 can also present information such as top 10 attributes per item type and/or item category based on how most or lease frequently those attributes have been updated. This information can also be presented in tables or other visual depictions described in FIGS. 6-12. Moreover, although not depicted, the application 620 can also include one or more selectable options to perform operations based on the outputted information. For example, the application 620 can present options to contact one or more item suppliers, manually update information in one or more item listings, etc., as described throughout this disclosure.

As described herein, one or more of the values in the tables 902 and 904 can be represented in different indicia, such as colors. The indicia can represent an urgency of addressing particular quality issues with a particular item category and/or item listing. Refer to FIGS. 7-8 for further discussion.

FIG. 10 illustrates a user interface (such as a user interface of an employee computer terminal) displaying an example uniqueness IQI score 1000, which can be one of the individual IQI scores that comprises the composite IQI score. The uniqueness IQI score 1000 can measure how unique an item listing data entry is and whether that data entry is duplicated elsewhere, across different systems. The uniqueness IQI score 1000 can be depicted in the application 620, described in FIG. 6. A relevant user can be presented with the uniqueness IQI score 1000 and/or the user can select the uniqueness IQI score 608 in FIG. 6 to be directed to a new GUI display shown in FIG. 10.

The uniqueness IQI score 1000 can be based on item identifiers, such as barcodes, SKUs, and other unique item identifiers. An item identifiers policy of the retail environment can, for example, require a 1:1 relationship between an item identifier, DPCI, and barcode. Therefore, if an item listing breaks this policy, the uniqueness IQI score 1000 can be lowered. This would indicate that one or more items are identified by a same item identifier, DPCI, barcode, or other item identifier. The uniqueness IQI score 1000 can also be measured based on item (e.g., product) titles. Each item can be unique in some way (e.g., based on brand, size, color, shade, etc.) and the description of the item in the item's title should reflect that uniqueness. Thus, if one or more item titles are the same (e.g., have same descriptions), then the uniqueness IQI score 1000 can be lowered.

The uniqueness IQI score 1000 can be depicted in a table. The table can list, for each item category, a title uniqueness score 1002, a barcode uniqueness score 1004, and an aggregate uniqueness score 1006. The score 1002 can indicate a quantity of item listings in the particular item category having a unique title. The score 1004 can indicate a quantity of item listings in the particular item category having a unique barcode or other identifier. The table can also depict, for all the item categories, a grand total title uniqueness score 1002, a grand total barcode uniqueness score 1004, and a grand total uniqueness score 1006. The grand total uniqueness score 1006 can be the uniqueness IQI score 1000.

Grand total title uniqueness score 1008 can also be outputted as a shaded semi-circle as described with regards to FIGS. 6-9. As shown here, 88.83% of item listings have unique titles and approximately 12% of all item listings have issues with their titles. The title uniqueness score 1002 can also be presented as a table 1010. The table 1010 can indicate, for each item category, a total quantity of items, a total quantity of titles having issues, and the title uniqueness score. The table 1010 can be beneficial to provide a more granular view of how the title uniqueness score 1002 is determined for each item category.

Grand total barcode uniqueness score 1012 can also be outputted as a shaded semi-circle as described with regards to FIGS. 6-9. As shown here, 99.96% of item listings have unique barcodes. Thus, 99.96% of the semi-circle is shaded in the first indicia, which can be a green color representing the third range. After all, almost all of the item listing across all the item categories has a unique barcode and therefore does not need to be addressed at the present time. The barcode uniqueness score 1004 can also be presented as a table 1014. The table 1014 can indicate, for each item category, a total quantity of items, a total quantity of barcodes having issues, and the barcode uniqueness score. The table 1014 can be beneficial to provide a more granular view of how the barcode uniqueness score 1004 is determined for each item category.

Although not depicted, the application 620 can also include one or more selectable options to perform operations based on the outputted information. For example, the application 620 can present options to contact one or more item suppliers, manually update information in one or more item listings, etc., as described throughout this disclosure.

One or more of the values for each of the item categories can be represented in different indicia (e.g., colors) in the tables depicted in FIG. 10. Refer to FIG. 7 for further discussion about example indicia, such as green, yellow, and red colored table cells. In the example of FIG. 10, the title uniqueness score 1002 for all the categories except apparel/accessories and home can be represented in green colored cells while the score 1002 for apparel/accessories and home can be represented in yellow colored cells. The barcode uniqueness scores 1004 for all of the item categories can be represented in green colored cells. Moreover, the aggregate uniqueness scores 1006 for all the item categories except apparel/accessories can be represented in green colored cells. The score 1006 for apparel/accessories can be represented in a yellow colored cell. The title uniqueness score table 1010 can have the same indicia as the title uniqueness scores 1002. Similarly, the barcode uniqueness score table 1014 can have the same indicia as the barcode uniqueness scores 1004.

FIGS. 11A-E illustrate a user interface (such as a user interface of an employee computer terminal) displaying an example validity IQI score 1100, which can be one of the individual IQI scores that comprises the composite IQI score. The validity IQI score 1100 can measure/quantify whether the correct fields are used in an item listing. For example, the score 1100 can measure whether an appropriate taxonomy, legal values, and business rules are used. The score 1100 can also indicate whether the data that is recorded is a type of data that the retail environment is set out to record. The validity IQI score 1100 can be depicted in the application 620, described in FIG. 6. A relevant user can be presented with the validity IQI score 1100 and/or the user can select the validity IQI score 610 in FIG. 6 to be directed to a new GUI display shown in FIG. 11.

As shown in FIG. 11A, the validity IQI score 1100 can be generated based on data matches across different systems. The validity IQI score 1100 can be outputted as a table. The table can indicate, for each item category, total item identifiers 1102, illegal taxonomy count 1104, and an aggregate validity score 1106. The score 1106 for a particular item category can be an inverse of the illegal taxonomy count 1104 divided by the total item identifiers 1102. The table can also indicate, for all the item categories, a grand total of total item identifiers 1102, a grand total of illegal taxonomy count 1104, and a grand total validity score 1106. The grand total validity score 1106 can be the validity IQI score 1100.

The aggregate validity scores 1106 for each of the item categories can be represented in different indicia (e.g., colors) in the table. Refer to FIG. 7 for further discussion about example indicia, such as green, yellow, and red colored table cells. In the example of FIG. 11, the aggregate validity scores 1106 for apparel/accessories and food/beverage can be represented in green colored cells in the table. The aggregate validity scores 1106 for beauty/cosmetics, essentials, hardlines, and home categories can be represented in yellow colored cells, thereby drawing the relevant user's attention to review those categories.

A validity type table 1108 can also be presented in the application 620. The table 1108 can present more granular information about the validity IQI score 1100. For example, the table 1108 can list item identifier legalities (e.g., validity types) and corresponding illegal taxonomy counts. The relevant user can review each of the listed item identifier legalities in the table 1108 to determine how to address and improve the validity IQI score 1100.

A top 10 illegal merchandise type table 1110 can also be presented in the application 620. The table 1110 can output top 10 merchandise types and the corresponding illegal taxonomy counts. The user can review the table 1110 to determine which merchandise types across all the item categories should be addressed to improve the validity IQI score 1100.

Moreover, a top 10 illegal item type table 1112 can be presented in the application 620. The table 1112 can output top 10 item types and the corresponding illegal taxonomy counts. The user can review the table 1112 to determine which item types across all the item categories should be addressed to improve the validity IQI score 1100.

One or more additional tables may also be presented in the application 620, as shown in FIGS. 11B, 11C, 11D, and 11E. For example, in both FIGS. 11B and 11C, the application 620 can present a merchant type validity table 1114, an item type validity table 1116, an MTA validity table 1118, an MTA value validity table 1120, and a brand validity table 1122. In particular, the brand validity table 1122 can measure accuracy of brand identifiers (IDs). The table 1122 can include, for each category of items, a total brand count, an anomaly brand count, and an anomaly percentage. The anomaly percentage can be a ratio of anomaly brand count to total brand count. The table 1122 can also include a total brand count for all the categories, a total anomaly brand count, and a total anomaly percentage. The brand validity table 1122 can be used by the user to improve the validity IQI score 1100 based on accuracy of brand IDs.

Both FIGS. 11D and 11E depict additional information that may be presented in the application 620 with regards to the validity item quality index score 1100. Although FIGS. 11D and 11E refer to the validity item quality index score 1100, similar information and/or visualizations can be presented in the application 620 for the accuracy item quality index score 700, the completeness item quality index score 800, the timeliness item quality index score 900, the uniqueness item quality index score 1000, and the consistency item quality index score 1200.

As shown in FIGS. 11D and 11E, a validity score 1124 can be visually depicted in the application 620 as a circle graphical element. The circle can be shaded in a color that correlates to the validity score 1124. In this example, the validity score 1124 is 95.54. Accordingly, the circle is shaded in a green color, since the validity score 1124 is a high/good score (e.g., a score that exceeds some threshold level). The application 620 can include one or more tables, such as a validity index score table 1126 and a validity type—invalid taxonomy count table 1128.

The application 620 can also present graphs 1130, 1132, and 1134. The graphs 1130, 1132, and 1134 can present validity anomalies over one or more different periods of time. For example, the graph 1130 depicts total validity anomalies on a week by week basis. Total anomalies per week are depicted as bars in the graph 1130. A curve extends over the bars in the graph 1130 to depict a percent change in total anomalies from week to week.

The graph 1132 depicts total validity anomalies on a month by month basis. Total anomalies per month are depicted as bars in the graph 1132. A curve extends over the bars in the graph 1132 to depict a percent change in total anomalies from month to month.

Similarly, the graph 1134 depicts total validity anomalies on a year to year basis. Total anomalies per year are depicted as bars in the graph 1134. In this example, validity has only been measured for one year, so the graph 1134 only includes one bar. A curve extends over the bar in the graph 1134 to depict a percent change in total anomalies from year to year. Here, there has been a 0% change in total validity anomalies since validity has only been measured for one year (and thus cannot be compared to other years).

Although not depicted, the application 620 can also include one or more selectable options to perform operations based on the outputted information. For example, the application 620 can present options to contact one or more item suppliers, manually update information in one or more item listings, etc., as described throughout this disclosure

FIGS. 12A-E illustrate a user interface (such as a user interface of an employee computer terminal) displaying an example consistency IQI score 1200, which can be one of the individual IQI scores that comprises the composite IQI score. The consistency IQI score 1200 can measure/quantify whether item listing data is consistent across different data sets and across different systems. The consistency IQI score 1200 can measure consistency of data between different source systems, source systems to computing systems and retail environment data stores, and retail environment data stores to end consumers and/or users. The consistency IQI score 1200 can also measure consistency across various items of a similar type and/or across various items from a particular supplier, vendor, manufacturer, and/or distributor. The consistency IQI score 1200 can be depicted in the application 620, described in FIG. 6. A relevant user can be presented with the consistency IQI score 1200 and/or the user can select the consistency IQI score 612 in FIG. 6 to be directed to a new GUI display shown in FIG. 12.

As shown in FIG. 12A, the consistency IQI score 1200 can be determined based on how many item listings have inaccurate taxonomy counts. Thus, the consistency IQI score 1200 can be depicted in a table. The table can output, for each item category, a total item identifiers 1202, an inaccurate taxonomy count 1204, and an aggregate consistency score 1206. The score 1206 for a particular item category can be an inverse of the inaccurate taxonomy count 1204 divided by the total item identifiers 1202. The table can also indicate, for all the item categories, a grand total of total item identifiers 1202, a grand total of inaccurate taxonomy count 1204, and a grand total consistency score 1206. The grand total consistency score 1206 can be the consistency IQI score 1200.

The aggregate consistency score 1206 for each of the item categories can be represented in different indicia (e.g., colors) in the table. Refer to FIG. 7 for further discussion about example indicia, such as green, yellow, and red colored table cells. In the example of FIG. 12, the aggregate consistency scores 1206 for apparel/accessories, beauty/cosmetics, and food/beverage can be represented in green colored cells in the table. The aggregate consistency scores 1206 for essentials, hardlines, and home categories can be represented in yellow colored cells, thereby drawing the relevant user's attention to review those categories.

A consistency type table 1208 can also be presented in the application 620. The table 1208 can present more granular information about the consistency IQI score 1200. For example, the table 1208 can list item identifier legalities (e.g., consistency types) and corresponding inaccurate taxonomy counts. The relevant user can review each of the listed item identifier legalities in the table 1208 to determine how to address and improve the consistency IQI score 1200.

A top 10 inaccurate merchandise type table 1210 can also be presented in the application 620. The table 1210 can output top 10 merchandise types and the corresponding consistency taxonomy counts. The user can review the table 1210 to determine which merchandise types across all the item categories should be addressed to improve the consistency IQI score 1200.

Moreover, a top 10 inaccurate item type table 1212 can be presented in the application 620. The table 1212 can output top 10 item types and the corresponding consistency taxonomy counts. The user can review the table 1212 to determine which item types across all the item categories should be addressed to improve the consistency IQI score 1200.

One or more additional tables may also be presented in the application 620, as shown in FIGS. 12B-E. For example, in both FIGS. 12B and 12C, the application 620 can present a merchant type consistency table 1214, an item type consistency table 1216, an MTA consistency table 1218, an MTA value consistency table 1220, and a brand consistency table 1222. In particular, the brand consistency table 1222 can measure accuracy of brand identifiers (IDs). The table 1222 can include, for each category of items, a total brand count, an anomaly brand count, and an anomaly percentage. The anomaly percentage can be a ratio of anomaly brand count to total brand count. The table 1222 can also include a total brand count for all the categories, a total anomaly brand count, and a total anomaly percentage. The brand consistency table 1222 can be used by the user to improve the consistency IQI score 1200 based on accuracy of brand IDs.

Both FIGS. 12D and 12E depict additional information that may be presented in the application 620 with regards to the consistency item quality index score 1200. A consistency score 1224 can be visually depicted in the application 620 as a circle graphical element. The circle can be shaded in a color that correlates to the consistency score 1224. In this example, the consistency score 1224 is 97.67. Accordingly, the circle is shaded in a green color, since the consistency score 1224 is a high/good score (e.g., a score that exceeds some threshold level). The application 620 can include one or more tables, such as a consistency index score table 1226 and a consistency type—inconsistency taxonomy count table 1228.

The application 620 can also present graphs 1230, 1232, and 1234. The graphs 1230, 1232, and 1234 can present consistency anomalies over one or more different periods of time. For example, the graph 1230 depicts total consistency anomalies on a week by week basis. Total anomalies per week are depicted as bars in the graph 1230. A curve extends over the bars in the graph 1230 to depict a percent change in total anomalies from week to week.

The graph 1232 depicts total consistency anomalies on a month by month basis. Total anomalies per month are depicted as bars in the graph 1232. A curve extends over the bars in the graph 1232 to depict a percent change in total anomalies from month to month.

Similarly, the graph 1234 depicts total consistency anomalies on a year to year basis. Total anomalies per year are depicted as bars in the graph 1234. In this example, consistency has only been measured for one year, so the graph 1234 only includes one bar. A curve extends over the bar in the graph 1234 to depict a percent change in total anomalies from year to year. Here, there has been a 0% change in total consistency anomalies since consistency has only been measured for one year (and thus cannot be compared to other years).

Although not depicted, the application 620 can also include one or more selectable options to perform operations based on the outputted information. For example, the application 620 can present options to contact one or more item suppliers, manually update information in one or more item listings, etc., as described throughout this disclosure.

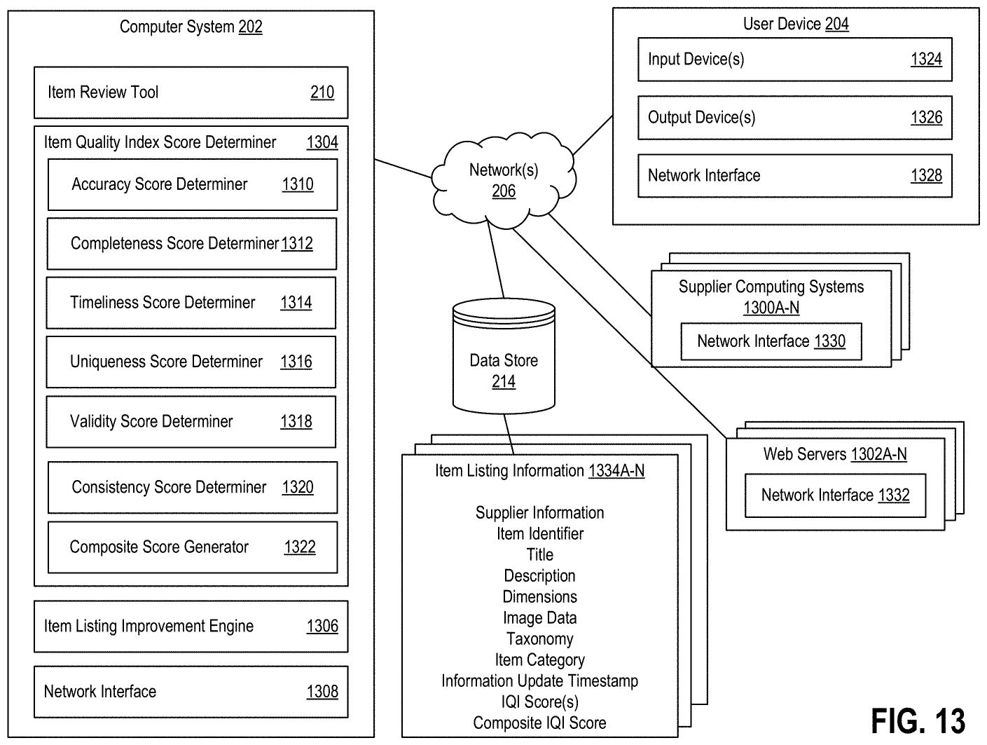

FIG. 13 is a system diagram depicting one or more components that can be used to perform the techniques described herein. The computer system 202, the user device 204, the data store 214, supplier computing systems 1300A-N, and web servers 1302A-N can be in communication (e.g., wired, wireless) via the network(s) 206. Although depicted as separate components, in some implementations, one or more of the components in FIG. 13 can be part of a same computer, system, and/or network. For example, the computer system 202 and the user device 204 can be a same computing system. As another example, the computer system 202 and the data store 214 can be part of a same cloud-based service and/or system. As yet another example, the computer system 202 can be part of one or more of the supplier computing systems 1300A-N. One or more other combinations or variations of the components in FIG. 13 may be possible.

The data store 214 can be configured to store item listing information 1334A-N. The item listing information 1334A-N can be data records and/or datasets having information about a particular item that is listed for sale in an online and/or physical retail environment. The item listing information 1334A-N can include, for each item listing, supplier information, item identifier (e.g., item ID, product identifier), title, description, dimensions, image data, taxonomy, item category, information update timestamp, IQI score(s), and composite IQI score. The item listing information 1334A-N can be provided to the data store 214 for storage by one or more components in FIG. 13. For example, one or more of the data in the item listing information 1334A-N can be assessed/determined by the item review tool 210 of the computer system 202. As another example, the IQI score(s) and the composite IQI score can be determined by the computer system 202 and transmitted to the data store 214 for storage in the corresponding item listing information 1334A-N. The item listing information 1334A-N can also be updated over time by one or more of the user devices 204, the computer system 202, and the supplier computing systems 1300A-N. For example, a supplier computing system 1300A can provide the computer system 202 with updated description, dimensions, image data, etc. for a particular item. The computer system 202 can then update the corresponding item listing information 1334A-N data record with the data received from the supplier computing system 1300A. As another example, the user device 204 can be operated by a retail store employee. The retail store employee can manually review a particular item in the physical retail environment and, based on their review, input updated or new information to the user device 204. The user device 204 can then transmit the updated or new information to the data store 214 to be stored in the corresponding item listing information 1334A-N data record.

The computer system 202 can be configured to analyze item listings data and determine IQI scores and composite IQI scores for the item listings and categories of items, as described throughout this disclosure. The computer system 202 can include components that may include the item review tool 210, an item quality index score determiner 1304, an item listing improvement engine 1306, and a network interface 1308.

The item review tool 210 can be configured to analyze item listings that are presented in web browsers at user devices 204 and detect quality issues in those item listings. For example, the item review tool 210 can identify data fields in the item listings that are missing information. As another example, the item review tool 210 can use optical character recognition (OCR) and image processing techniques to detect item information from image data and compare the detected information to known information about the item listings. Identifications, analysis, and determinations made by the item review tool 210 can be transmitted to the data store 214 for storage in a corresponding item listing information 1334A-N data record. Refer to FIG. 2 for additional discussion about the item review tool 210.

The item quality index score determiner 1304 can be configured to determine, for each item listing and/or a category of items, IQI scores for each IQI scoring metric. The determiner 1304 can also determine, for each item listing and/or category of items, a composite IQI score based on the IQI scores for each scoring metric. Accordingly, the determiner 1304 can include an accuracy score determiner 1310, a completeness score determiner 1312, a timeliness score determiner 1314, a uniqueness score determiner 1316, a validity score determiner 1318, a consistency score determiner 1320, and a composite score generator 1322. Each of the determined scores can also be stored in the corresponding item listing information 1334A-N as IQI score(s) and/or composite IQI score.

The accuracy score determiner 1310 can be configured to analyze item listing information 1334A-N and determine an accuracy IQI score for each item listing and/or category of items. The determiner 1310 can, for example, retrieve item listing information 1334A-N for a particular category of items and, for each of the retrieved item listing information 1334A-N data records, determine whether the title and dimensions are correct for the particular items. The determiner 1310 can also generate output about the determined accuracy IQI score, as described herein. Refer to FIGS. 3 and 7 for additional discussion about determining the accuracy IQI score.

The completeness score determiner 1312 can be configured to analyze item listing information 1334A-N and determine a completeness IQI score for each item listing and/or category of items. The determiner 1312 can, for example, retrieve item listing information 1334A-N for a particular category of items and, for each of the retrieved item listing information 1334A-N data records, determine whether the data in the item listing information 1334A-N, such as description, image data, supplier, information, etc. are complete/filled in. The determiner 1312 can also generate output about the determined completeness IQI score, as described herein. Refer to FIGS. 3 and 8 for additional discussion about determining the completeness IQI score.

The timeliness score determiner 1314 can be configured to analyze item listing information 1334A-N and determine a timeliness IQI score for each item listing and/or category of items. The determiner 1314 can, for example, retrieve item listing information 1334A-N for a particular category of items and, for each of the retrieved item listing information 1334A-N data records, determine when the item listing information 1334A-N was last updated and how frequently it was/is updated. The determiner 1314 can, determine whether the information update timestamp in the item listing information 1334A-N falls within one or more predetermined periods of time, where each of the predetermined periods of time indicate different levels of timeliness (0-3 months is most timely, 3-6 months is somewhat timely, 6-12 months is less timely, and 12+ months is not timely). The determiner 1314 can also generate output about the determined timeliness IQI score, as described herein. Refer to FIGS. 3 and 9 for additional discussion about determining the timeliness IQI score.

The uniqueness score determiner 1316 can be configured to analyze item listing information 1334A-N and determine a uniqueness IQI score for each item listing and/or category of items. The determiner 1316 can, for example, retrieve item listing information 1334A-N for a particular category of items and, for each of the retrieved item listing information 1334A-N data records, determine whether the title and item identifier are used to identify more than one item (and therefore not unique). The determiner 1316 can also generate output about the determined uniqueness IQI score, as described herein. Refer to FIGS. 3 and 10 for additional discussion about determining the uniqueness IQI score.

The validity score determiner 1318 can be configured to analyze item listing information 1334A-N and determine a validity IQI score for each item listing and/or category of items. The determiner 1318 can, for example, retrieve item listing information 1334A-N for a particular category of items and, for each of the retrieved item listing information 1334A-N data records, determine whether the description, dimensions, taxonomy, item category, etc. are legal values, comply with business policies/rules, or otherwise are valid for the particular item. The determiner 1318 can also generate output about the determined validity IQI score, as described herein. Refer to FIGS. 3 and 11 for additional discussion about determining the validity IQI score.

The consistency score determiner 1320 can be configured to analyze item listing information 1334A-N and determine a consistency IQI score for each item listing and/or category of items. The determiner 1320 can, for example, retrieve item listing information 1334A-N for a particular category of items and, for each of the retrieved item listing information 1334A-N data records, determine whether any of the data in the item listing information 1334A-N is consistent across different systems, computers, data stores, etc. For example, the determiner 1320 can determine whether the same data is recorded in the data store 214 and the supplier computing systems 1300A-N. The determiner 1320 can also generate output about the determined consistency IQI score, as described herein. Refer to FIGS. 3 and 11 for additional discussion about determining the consistency IQI score.

The composite score generator 1322 can be configured to generate a composite IQI score for a particular item listing and/or category of items. The generator 1322 can generate the composite IQI score based on weighting and averaging the accuracy, completeness, timeliness, uniqueness, validity, and consistency IQI scores. The determiner 1322 can also generate output about the determined composite IQI score, as described herein. Refer to FIGS. 3 and 6 for additional discussion about determining the composite IQI score.

The item listing improvement engine 1306 can be configured to determine one or more operations that can be performed based on the scores generated by the item quality index score determiner 1304. The operations can be automatically performed/executed by the computer system 202, such as transmitting a request for updated information to one or more supplier computing systems 1300A-N. The operations can also be manually performed/executed by a relevant user at the user device 204. In some implementations, the engine 1306 can also generate output about the scores and/or operations to be presented at the user device 204. Refer to FIGS. 2-5 for further discussion about determining operations to perform based on the IQI scores and/or the composite IQI score.

The user device 204 can be a computer, tablet, laptop, mobile phone, cloud-based system or service, or other computing system/device that can be used by a relevant user to assess item listing information. The relevant user can be a retail environment employee who can be tasked with reviewing item listing data and performing quality control based on the reviewed item listing data. The relevant user can, for example, review a particular item in the physical retail environment, provide their insights about the particular item via the user device 204 to the computer system 202, receive output from the computer system 202 in the form of IQI scores, the composite IQI score, and/or item listing improvement suggestions, and make decisions about how to improve the quality of the item listing for the particular item based on the output from the computer system 202.

Accordingly, the user device 204 can include input device(s) 1324, output device(s) 1326, and a network interface 1328. The input device(s) 1324 can include, but may not be limited to, a touchscreen, mouse, keyboard, microphone, or any other type of input device. The relevant user can provide information about an item listing to the user device 204 using the input device(s) 1324. Such information can include visual identification and/or inspection of any one or more of the data in the corresponding item listing information 1334A-N, decisions about what operations to take in order to improve the quality of the item listing information 1334A-N, requests for one or more of the data in the item listing information 1334A-N, and/or requests for one or more different views/GUI displays of the item listing information 1334A-N, the IQI scores, and/or the composite IQI score. The input device(s) 1324 can also be used by the user to provide one or more other inputs to the user device 204.

The output device(s) 1326 can include, but may not be limited to, a touch screen, speakers, display, or any other type of output device. The relevant user can view information about an item listing at the user device 204 via the output device(s) 1326. Such information can include any one or more of the data in the item listing information 1334, the IQI scores, the composite IQI score, and/or quality improvement suggestions generated by the computer system 202. The output device(s) 1326 can also be used to provide the user with one or more other outputs presented in graphical user interface (GUI) displays at the user device 204. Refer to FIGS. 6-12 for example GUI displays that can be outputted at the user device 204.

The supplier computing systems 1300A-N can be configured to generate, update, and store information about items provided by suppliers to the retail environment. The supplier computing systems 1300A-N can each include a network interface 1330. Each supplier can maintain a respective supplier computing system 1300A-N. In some implementations, the supplier computing systems 1300A-N can include at least a computing device and a data store. The computing device can be used by the supplier to input information about each item that is provided by the supplier to the retail environment. The computing device can also be configured to receive requests for new, additional, and/or updated information from the computer system 202 and/or the user device 204. The supplier can then input the requested information to the computing device, which can be transmitted to the computer system 202 and/or the user device 204 to be stored in the corresponding item listing information 1334A-N in the data store 214. The data store of the supplier computing systems 1300A-N can be configured to maintain supplier-determined/generated information about each of the supplier's items. The data store can therefore maintain information such as a supplier code/identifier, title, description, image data, dimensions, item category, and other information that is determined by the supplier. Any of the information in the data store can be transmitted to the computer system 202 and/or the user device 204 upon request. In some implementations, the consistency score determiner 1320 of the computer system 202 can compare information stored in the data store 214 with information stored in the data store of the supplier computing systems 1300A-N.

The web servers 1302A-N can be configured to store, process, and deliver web pages to users at computing devices, such as the user device 204. The web servers 1302A-N can each include a network interface 1332. The web servers 1302A-N can deliver item listings in web pages for the online retail environment. The item listings can be delivered to the computing devices of consumers so that the consumers can view the items available for purchase and make purchasing decisions. The item listings can also be delivered to retail store employees at their respective user devices 204 so that the retail store employees can assess and address quality of the item listings.

As an illustrative example, the website 100 depicted in FIG. 1A can be delivered by a web server 1302A to a computing device of an end-consumer. As another illustrative example, the website 100 with the pop out window 142 depicted in FIG. 1B can be delivered by the web server 1302A to the user device 204 of a retail store employee. As yet another example, when the item review tool 210 of the computer system 202 reviews an item listing, the tool 210 can request a webpage having the item listing from the web server 1302A. The web server 1302A can serve the requested webpage to the tool 210, which can be analyzed by the tool 210 to identify information (or missing information) in the item listing.

The network interfaces 1308, 1328, 1330, and 1332 can provide for communication between the components described herein.

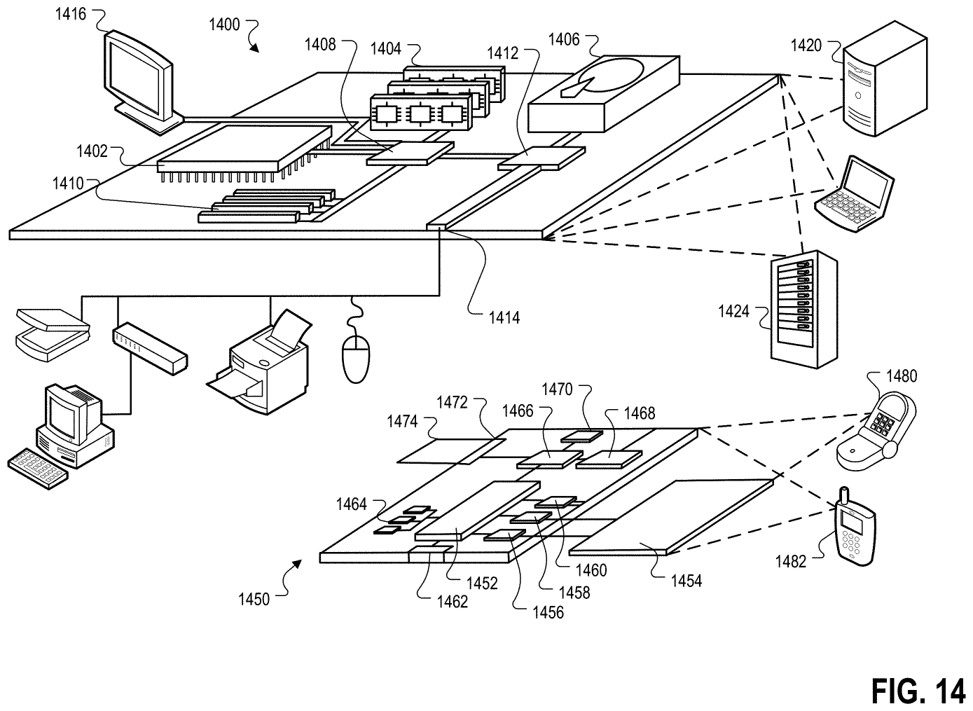

FIG. 14 shows an example of a computing device 1400 and an example of a mobile computing device that can be used to implement the techniques described here. The computing device 1400 is intended to represent various forms of digital computers, such as laptops, desktops, workstations, personal digital assistants, servers, blade servers, mainframes, and other appropriate computers. The mobile computing device is intended to represent various forms of mobile devices, such as personal digital assistants, cellular telephones, smart-phones, and other similar computing devices. The components shown here, their connections and relationships, and their functions, are meant to be exemplary only, and are not meant to limit implementations of the inventions described and/or claimed in this document.

The computing device 1400 includes a processor 1402, a memory 1404, a storage device 1406, a high-speed interface 1408 connecting to the memory 1404 and multiple high-speed expansion ports 1410, and a low-speed interface 1412 connecting to a low-speed expansion port 1414 and the storage device 1406. Each of the processor 1402, the memory 1404, the storage device 1406, the high-speed interface 1408, the high-speed expansion ports 1410, and the low-speed interface 1412, are interconnected using various busses, and can be mounted on a common motherboard or in other manners as appropriate. The processor 1402 can process instructions for execution within the computing device 1400, including instructions stored in the memory 1404 or on the storage device 1406 to display graphical information for a GUI on an external input/output device, such as a display 1416 coupled to the high-speed interface 1408. In other implementations, multiple processors and/or multiple buses can be used, as appropriate, along with multiple memories and types of memory. Also, multiple computing devices can be connected, with each device providing portions of the necessary operations (e.g., as a server bank, a group of blade servers, or a multi-processor system).

The memory 1404 stores information within the computing device 1400. In some implementations, the memory 1404 is a volatile memory unit or units. In some implementations, the memory 1404 is a non-volatile memory unit or units. The memory 1404 can also be another form of computer-readable medium, such as a magnetic or optical disk.

The storage device 1406 is capable of providing mass storage for the computing device 1400. In some implementations, the storage device 1406 can be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product can also contain instructions that, when executed, perform one or more methods, such as those described above. The computer program product can also be tangibly embodied in a computer- or machine-readable medium, such as the memory 1404, the storage device 1406, or memory on the processor 1402.

The high-speed interface 1408 manages bandwidth-intensive operations for the computing device 1400, while the low-speed interface 1412 manages lower bandwidth-intensive operations. Such allocation of functions is exemplary only. In some implementations, the high-speed interface 1408 is coupled to the memory 1404, the display 1416 (e.g., through a graphics processor or accelerator), and to the high-speed expansion ports 1410, which can accept various expansion cards (not shown). In the implementation, the low-speed interface 1412 is coupled to the storage device 1406 and the low-speed expansion port 1414. The low-speed expansion port 1414, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter.

The computing device 1400 can be implemented in a number of different forms, as shown in the figure. For example, it can be implemented as a standard server 1420, or multiple times in a group of such servers. In addition, it can be implemented in a personal computer such as a laptop computer 1422. It can also be implemented as part of a rack server system 1424. Alternatively, components from the computing device 1400 can be combined with other components in a mobile device (not shown), such as a mobile computing device 1450. Each of such devices can contain one or more of the computing device 1400 and the mobile computing device 1450, and an entire system can be made up of multiple computing devices communicating with each other.

The mobile computing device 1450 includes a processor 1452, a memory 1464, an input/output device such as a display 1454, a communication interface 1466, and a transceiver 1468, among other components. The mobile computing device 1450 can also be provided with a storage device, such as a micro-drive or other device, to provide additional storage. Each of the processor 1452, the memory 1464, the display 1454, the communication interface 1466, and the transceiver 1468, are interconnected using various buses, and several of the components can be mounted on a common motherboard or in other manners as appropriate.

The processor 1452 can execute instructions within the mobile computing device 1450, including instructions stored in the memory 1464. The processor 1452 can be implemented as a chipset of chips that include separate and multiple analog and digital processors. The processor 1452 can provide, for example, for coordination of the other components of the mobile computing device 1450, such as control of user interfaces, applications run by the mobile computing device 1450, and wireless communication by the mobile computing device 1450.

The processor 1452 can communicate with a user through a control interface 1458 and a display interface 1456 coupled to the display 1454. The display 1454 can be, for example, a TFT (Thin-Film-Transistor Liquid Crystal Display) display or an OLED (Organic Light Emitting Diode) display, or other appropriate display technology. The display interface 1456 can comprise appropriate circuitry for driving the display 1454 to present graphical and other information to a user. The control interface 1458 can receive commands from a user and convert them for submission to the processor 1452. In addition, an external interface 1462 can provide communication with the processor 1452, so as to enable near area communication of the mobile computing device 1450 with other devices. The external interface 1462 can provide, for example, for wired communication in some implementations, or for wireless communication in other implementations, and multiple interfaces can also be used.

The memory 1464 stores information within the mobile computing device 1450. The memory 1464 can be implemented as one or more of a computer-readable medium or media, a volatile memory unit or units, or a non-volatile memory unit or units. An expansion memory 1474 can also be provided and connected to the mobile computing device 1450 through an expansion interface 1472, which can include, for example, a SIMM (Single In Line Memory Module) card interface. The expansion memory 1474 can provide extra storage space for the mobile computing device 1450, or can also store applications or other information for the mobile computing device 1450. Specifically, the expansion memory 1474 can include instructions to carry out or supplement the processes described above, and can include secure information also. Thus, for example, the expansion memory 1474 can be provide as a security module for the mobile computing device 1450, and can be programmed with instructions that permit secure use of the mobile computing device 1450. In addition, secure applications can be provided via the SIMM cards, along with additional information, such as placing identifying information on the SIMM card in a non-hackable manner.

The memory can include, for example, flash memory and/or NVRAM memory (non-volatile random access memory), as discussed below. In some implementations, a computer program product is tangibly embodied in an information carrier. The computer program product contains instructions that, when executed, perform one or more methods, such as those described above. The computer program product can be a computer- or machine-readable medium, such as the memory 1464, the expansion memory 1474, or memory on the processor 1452. In some implementations, the computer program product can be received in a propagated signal, for example, over the transceiver 1468 or the external interface 1462.

The mobile computing device 1450 can communicate wirelessly through the communication interface 1466, which can include digital signal processing circuitry where necessary. The communication interface 1466 can provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication can occur, for example, through the transceiver 1468 using a radio-frequency. In addition, short-range communication can occur, such as using a Bluetooth, WiFi, or other such transceiver (not shown). In addition, a GPS (Global Positioning System) receiver module 1470 can provide additional navigation- and location-related wireless data to the mobile computing device 1450, which can be used as appropriate by applications running on the mobile computing device 1450.

The mobile computing device 1450 can also communicate audibly using an audio codec 1460, which can receive spoken information from a user and convert it to usable digital information. The audio codec 1460 can likewise generate audible sound for a user, such as through a speaker, e.g., in a handset of the mobile computing device 1450. Such sound can include sound from voice telephone calls, can include recorded sound (e.g., voice messages, music files, etc.) and can also include sound generated by applications operating on the mobile computing device 1450.

The mobile computing device 1450 can be implemented in a number of different forms, as shown in the figure. For example, it can be implemented as a cellular telephone 1480. It can also be implemented as part of a smart-phone 1482, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

What is claimed is:

1. A method for determining quality of item listings in an online retail environment, the method comprising:
receiving, at a computing system, item listing data, wherein the item listing data includes information about items of one or more item categories that are available in the online retail environment for purchase at user computing devices of end consumers;
determining, by the computing system and for each of the item categories, one or more quality index scores based on the information included in the item listing data, wherein the one or more quality index scores quantify one or more quality levels of the item listing data for the items in each of the item categories;
determining, by the computing system and for each of the item categories, a composite quality index score based on an aggregation of the determined one or more quality index scores for the items in each of the item categories; and
generating, by the computing system and based on the determined composite quality index score, output for each of the item categories for presentation on a display screen of a user computing device of a retail employee.

2. The method of claim 1, wherein generating, by the computing system and based on the determined composite quality index score, output for each of the item categories comprises determining one or more operations that can be performed to improve at least one of (i) the composite quality index score and (ii) one or more of the determined quality index scores,
wherein the one or more operations include instructions that, when executed by the computing system, cause at least one of:
(i) a notification to be sent to the user computing device of the retail employee requesting updated information for one or more of the items in one or more of the item categories from a supplier of the one or more items, and
(ii) a notification to be sent to the user computing device of the retail employee requesting input from the retail employee for updated information for one or more items in one or more of the item categories.

3. The method of claim 1, wherein the one or more quality index scores include an accuracy score, a completeness score, a timeliness score, a uniqueness score, a validity score, and a consistency score.

4. The method of claim 3, wherein determining, by the computing system and for each of the item categories, a composite quality index score comprises:
weighting each of the determined one or more quality index scores; and
averaging the weighted quality index scores to generate the composite quality index score,
wherein the accuracy score is weighted within a first range of 25-30% of the composite quality index score, the completeness score is weighted within a second range of 20-25% of the composite quality index score, the timeliness score is weighted within a third range of 10-15% of the composite quality index score, the uniqueness score is weighted within a fourth range of 10-15% of the composite quality index score, the validity score is weighted within a fifth range of 0-5% of the composite quality index score, and the consistency score is weighted within a sixth range of 0-5% of the composite quality index score.

5. The method of claim 3, further comprising determining, by the computing system and for each of the item categories, the accuracy score based on:
identifying an average item certification value, wherein the average item certification value is an aggregation of item certification values for the items that is determined based on the corresponding item listing data;
identifying an average title accuracy value as an aggregation of title accuracy values for the items that is determined based on the corresponding item listing data;
identifying an average package dimension accuracy as an aggregation of package dimension accuracy values for the items that is determined based on the corresponding item listing data; and
averaging the average item certification value, the average title accuracy value, and the average package dimension accuracy value to generate the accuracy score.

6. The method of claim 3, further comprising determining, by the computing system and for each of the item categories, the completeness score based on:
identifying an average required merchandise type attribute (MTA) value as an aggregation of required MTA values for the items that is determined based on the corresponding item listing data;
identifying an average content value as an aggregation of content values for the items that is determined based on the corresponding item listing data; and
averaging the average required MTA value and the average content value to generate the completeness score.

7. The method of claim 6, wherein generating, by the computing system and based on the determined composite quality index score, output for each of the item categories comprises:
identifying a threshold quantity of missing required MTAs for one or more of the item categories; and
generating output that includes the identified missing required MTAs and corresponding quantities of items that are missing the identified missing required MTAs in the respective item listing data, wherein the identified missing required MTAs include at least one of a targeted audience, stretch, color specific description, pattern group, color family, number of pieces, product weight, gender, apparel and accessories subtype, and garment neckline type.

8. The method of claim 7, wherein generating, by the computing system and based on the determined composite quality index score, output for each of the item categories comprises:
identifying a threshold quantity of vendors associated with missing required MTAs for one or more of the item categories; and
generating output that includes at least the identified vendors.

9. The method of claim 3, further comprising determining, by the computing system and for each of the item categories, the timeliness score based on:
determining a quantity of item listings that have been updated within a threshold period of time; and
dividing the quantity of item listings that have been updated within the threshold period of time by a total quantity of item listings in the item category to generate the timeliness score.

10. The method of claim 3, further comprising determining, by the computing system and for each of the item categories, the uniqueness score based on:
identifying an average title uniqueness value as an aggregation of title uniqueness values for the items that is determined based on the corresponding item listing data;
identifying an average barcode uniqueness value as an aggregation of barcode uniqueness values for the items that is determined based on the corresponding item listing data; and
averaging the average title uniqueness value and the average barcode uniqueness value to generate the uniqueness score.

11. The method of claim 3, further comprising determining, by the computing system and for each of the item categories, the validity score based on:
identifying an average total quantity of item identifiers value as an aggregation of the quantity of item identifier values for the items that is based on the corresponding item listing data;
identifying an average illegal taxonomy count as an aggregation of illegal taxonomy counts for the items that is determined based on the corresponding item listing data; and
averaging the average total quantity of item identifiers value and the average illegal taxonomy count to generate the validity score.

12. The method of claim 11, wherein generating, by the computing system and based on the determined composite quality index score, output for each of the item categories comprises:
identifying a threshold quantity of illegal merchandise types or a threshold quantity of illegal item types for one or more of the item categories; and
generating output that includes at least the identified illegal merchandise types, the identified illegal item types, and illegal taxonomy counts that correspond to each of the identified illegal merchandise types and the identified illegal item types.

13. The method of claim 3, further comprising determining, by the computing system and for each of the item categories, the consistency score based on:
identifying an average total item identifiers value as an aggregation of item identifiers values for the items that is determined based on the corresponding item listing data;
identifying an average inaccurate taxonomy count as an aggregation of inaccurate taxonomy counts for the items that is based on the corresponding item listing data; and
averaging the average total item identifiers value and the average inaccurate taxonomy count to generate the consistency score.

14. The method of claim 13, wherein generating, by the computing system and based on the determined composite quality index score, output for each of the item categories comprises generating output indicating consistency types for the item categories and an inaccurate taxonomy count for each of the consistency types.

15. The method of claim 13, wherein generating, by the computing system and based on the determined composite quality index score, output for each of the item categories comprises:
identifying a threshold quantity of inaccurate merchandise types for one or more of the item categories; and
generating output that includes at least the identified inaccurate merchandise types and consistency taxonomy counts that correspond to each of the identified inaccurate merchandise types.

16. The method of claim 13, wherein generating, by the computing system and based on the determined composite quality index score, output for each of the item categories comprises:
identifying a threshold quantity of inaccurate item types for one or more of the item categories; and
generating output that includes at least the identified inaccurate item types and consistency taxonomy counts that correspond to each of the identified inaccurate item types.

17. The method of claim 3, wherein:
the accuracy score quantifies an accuracy of the item listing data for the items in each of the item categories,
the completeness score quantifies how much content is included in the item listing data for the items in each of the item categories,
the timeliness score quantifies how recent the item listing data for the items in each of the item categories has been updated and how often the item listing data for the items in each of the item categories is updated,
the uniqueness score quantifies whether the item listing data for the items in each of the item categories has a unique item title and item identifier,
the validity score quantifies whether the item listing data for the items in each of the item categories includes legal fields, values, and taxonomy, and
the consistency score quantifies whether the item listing data for the items in each of the item categories is consistent across one or more different computing systems and data stores.

18. The method of claim 4, further comprising:
determining, by the computing system, updated weights for the one or more quality index scores based on applying a machine learning model to historic item listing data, wherein the machine learning model was trained using training data sets to correlate historic quality index scores with current trends in end consumer purchase decisions and end consumer feedback about the items in each of the item categories to determine the updated weights for the corresponding one or more quality index scores; and
weighting, by the computing system, the one or more quality index scores with the updated weights.

19. The method of claim 4, further comprising:
determining, by the computing system, a score weight for each of the quality index scores based on historical changes made to the item listing data of the items in each of the item categories as a result of the item listing data having been assigned a low quality index score; and
weighting each of the quality index scores using the determined score weights.

20. A computing system for determining quality of item listings in an online retail environment, the computing system comprising:
one or more processors; and
one or more computer-readable devices including instructions that, when executed by the one or more processors, cause the computing system to perform operations that include:
receiving item listing data, wherein the item listing data includes information about items of one or more item categories that are available in the online retail environment for purchase at user computing devices of end consumers;
determining, for each of the item categories, one or more quality index scores based on the information included in the item listing data, wherein the one or more quality index scores quantify one or more quality levels of the item listing data for the items in each of the item categories;
determining, for each of the item categories, a composite quality index score based on an aggregation of the determined one or more quality index scores for the items in each of the item categories; and
generating, based on the determined composite quality index score, output for each of the item categories for presentation on a display screen of a user computing device of a retail employee.
